(19) United States
(12) Patent Application Publication
(10) Pub. No.: US 2005/0129580 A1
(43) Pub. Date: Jun. 16, 2005

(54) Microfluidic chemical reactor for the manufacture of chemically-produced nanoparticles

(76) Inventors: Philip R. Swinehart, Columbus, OH (US); Kimberly Pollard, Genoa Township, OH (US); Christopher McGee, Columbus, OH (US); Saman Dharmatilleke, Singapore (SG)

Correspondence Address: PEPPER HAMILTON LLP, ONE MELLON CENTER, 50TH FLOOR, 500 GRANT STREET, PITTSBURGH, PA, 15219, US

(21) Appl. No.: 10/788,967

(22) Filed: Feb. 26, 2004

Related U.S. Application Data
(60) Provisional application No. 60/449,590, filed on Feb. 26, 2003.

(51) Int. Cl. B01L 3/00

(52) U.S. Cl. 422/100

(57) ABSTRACT

The present invention discloses microfluidic modules for making nanocrystalline materials in a continuous flow process. The microfluidic modules include one or more flow path with mixing structures and one or more controlled heat exchangers to process the nanocrystalline materials and reagents in the flow path. The microfluidic modules can be interconnected to form microfluidic reactors that incorporate one or more process functions such as nucleation, growth, and purification.

### CROSS REFERENCE TO RELATED APPLICATIONS

This application claims the benefit and priority U.S. Provisional Application Ser. No. 60/449,590 filed Feb. 26, 2003 the contents of which are incorporated herein by reference in their entirety.

### BACKGROUND AND SUMMARY

There has been much interest in the development and use of nanoparticles, which are sometimes also referred to as “quantum dots”. These very small, specially composed particles have a wide variety of applications in biological and other sciences. For example, semiconductor crystal nanoparticles (“nanocrystals”) can be fluorescent, providing very sensitive luminescent reporters of biological states and processes. Such nanocrystals have also been modified to impart properties for water solubility in order to take advantage of the many biological, biochemical and industrial applications. Exemplary nanoparticle sizes may range for example from about 1 nm to 500 nm in each dimension, but preferably from 1 nm to 200 nm in each dimension. These particles may be fluorescent semiconductor particles, non-fluorescing semiconductor, magnetic, metal, metal alloy or ceramic (e.g., metal oxide, nitride or carbide) particles. Further, the core nanocrystalline particles can be over-layered or coated with different and/or alternating layers of semiconductors, inorganic insulators such as silicon oxides or aluminum oxides, silicon nitrides or oxy-nitrides or any of a great many metal, semiconducting, or insulating compounds and mixtures as appropriate to the function of the core particles. In the case of fluorescing nanoparticles, the overlayers, or shells, are chosen to aid in the quantum confinement and optical and chemical stability of the complete particles.

Such particles and structures may, for example, be doped with low concentrations of foreign substances such as transition metal elements and rare earth elements e.g. for the purpose of embodying them with special optical, magnetic, or other physical properties. The coating layers may be crystalline materials closely lattice matched to the underlying particles or layers, or may be “composite” mixtures of materials designed to adjust coatings to be perfectly closed around the underlying particles to prevent defects. Such defects include types that quench fluorescent activity, that allow destructive chemical reactions with the ambient media, or other defects. The coating may be chosen for its band gap energy in relation to the core particle. The layered particles may or may not also include organic layers, layers designed to functionalize the nanoparticles for attachment to other particles, molecules or biological entities like cells and tissues for many medical and diagnostic applications.

The total size of the coated or functionalized nanoparticles may in fact surpass the definition of nanoparticle size in one or more dimensions. Such applications may include, but not be limited to, tagging and identifying molecules, cells or cellular entities, photonic bandgap structures, lasers and light emitting devices of all kinds, dying or encoding information on other structures, devices or objects, or quantum computing applications. These are but a few of many possibilities and examples.

Much work has been done in the past to develop techniques for manufacturing chemically produced nanoparticles. For example, U.S. Pat. No. 6,179,912 and U.S. Pat. Pub. No. US 2002/0144644 both of which are incorporated herein by reference in their entirety, disclose continuous flow chemical reactor(s) and associated process(es) for producing semiconductor nanocrystals in a flow process.

The limitations of the macroscale reactors and batch process for making nanocrystals include limited control of nucleation and growth parameters, low yields, excessive use of solvents and toxic chemicals and exposure of workers to the chemicals. The wide particle size distribution of the batch process requires resource-consuming size selection for many applications. For example, the output wavelength of a fluorescent semiconductor nanocrystal is closely correlated with its size. In the batch process for fluorescent nanocrystal preparation, ligand exchange is performed by a long soak in a stirred vessel at room temperature under nitrogen. Alternatively, multiple cycles in which nanocrystals with their coordinating solvent are separated from a liquid, contacted with organic solvents such as pyridine at temperatures just above room temperature, and separated from the liquid are performed. In this stage of the process, the coordinating solvent such as TOPO or TOP is exchanged for another coordinating solvent such a pyridine that results in the generation of excess solvent waste.

The inventors have now discovered that in the context of a continuous flow process and an associated reactor for chemically producing nanoparticles of various types, it is advantageous to use fluid channels of very small dimension of less than 1 mm ID, but preferably from 1 μm to 300 μm. Such “microfluidic” channels provide enhanced ability to provide the same or similar nucleation, growth, or coating conditions for all of the nanoparticles in the microfluidic reactor, thereby generally decreasing size distribution and improving uniformity. A microfluidic module may be constructed of a multiplicity of layers of materials with one or more microfluidic channels designed and built from the “inside out”, which can provide internal fluid mixing (thus providing rapid thermal equalization), temperature control, sensing and/or other functions. A microfluidic reactor can be made from one or more interconnected microfluidic modules.

There is a need to make nanoparticles in a consistent manner on process equipment used to make different sized nanoparticles and nanoparticles with varying compositions. There is a need for a high degree of stability and brightness for fluorescent nanoparticles in various solvents and preferably water-based solutions in order to facilitate conjugation for medical and biological uses. In addition, it is important to be able to prepare an adequately large, reliable supply of the full spectrum of colors to support the development effort for bio-active reagents for these applications. To accomplish this goal, an optimized system for the controlled production of a range of specific size nanocrystals with a very small size distribution/sample is desirable. Ready commercial availability of such nanoparticles will accelerate their use in medical diagnostics, biological research, marking of materials and goods as well as bio-countermeasures and many other applications.

Embodiments of the present invention include microfluidic modules or columns that can be interconnected to form reactors to produce a variety of nanocrystals, nanoparticles, and in particular functionalized fluorescent nanocrystals. The microfluidic modules and systems made from them can provide nanocrystals with controllable, narrow size distributions (sharp colors) and wide information bandwidth. One embodiment of the present invention is a microfluidic module that produces chemically-derivatized or functionalized semiconductor nanoparticles in a continuous flow process with at least a single-column reactor wherein the nanocrystals are processed through to the point that the particles are stable and prepared for their intended use. The single column reactor may be formed in single module or it may be assembled from one or more fluidly interconnected modules. The chemically derivatized or functionalized nanoparticles may be used in a variety of environments including organic fluids, aqueous solutions, and biological systems.

One embodiment of the present invention is a microfluidic module comprising a flow path in the shape of a channel in a substrate, the flow path having a fluid inlet and a fluid outlet, the flow path in thermal contact with one or more independently controlled heat exchangers along the flow path for conditioning a nanocrystal forming reagent within the flow path. The flow path inlet receives the reagent and the outlet in the flow path is for removing conditioned reagent from the flow path. The flow path may include mixing structures within the flow channel. The flow path inlet and outlet are capable of forming a fluid tight seal with one or more fluid delivery devices. This microfluidic module by itself could be used for processes such as but not limted to nucleation or growth termination, but may also be divided into one or more sections each having a different function for processing nanocrystals. The microfluidic module can also have one or more flow paths, each flow path having an inlet and an outlet and one or more independently controllable heat exchangers. The plurality of flow paths may be separated or can be interconnected by valves for controlled isolation.

The flow path of the microfluidic module may include a nucleation section in which nucleation of nanocrystals occurs during a flow process. The nucleation section has a nucleation channel length and channel cross section and can include one or more controlled heat exchangers for conditioning a nanocrystal forming reagent to form nanocrystal nuclei and to maintain the nucleation section at a nucleation temperature that can include but is not limited to a constant temperature, endotherm or exotherm recovery, a temperature ramp, or a combination of these along the channel section in the flow path. The nucleation section may have one or more mixing structures in the flow path. The nucleation section includes at least one nucleation inlet in the flow path for receiving a nanocrystal forming reagent fluid to form nanocrystal nuclei and at least one nucleation outlet in the flow path for removing nucleated nanocrystals in a fluid such as an organic solvent from the nucleation section. The nucleation section inlet and outlet are each capable of forming fluid tight seals with one or more fluid delivery devices.

The flow path of the microfluidic module may include one or more growth sections in which growth of nucleated nanocrystals, growth of existing nanocrystals, or formation of a shell or capping layer over an existing core nanocrystal occurs during a flow process. The growth section has growth channel length and a growth channel cross section and can include one or more controlled heat exchangers for conditioning a nanocrystal forming reagent to grow nanocrystals and to maintain the growth section at a growth temperature which may include but is not limited to a constant temperature or a gradient. The flow path in the growth section may have one or more mixing structures in the channel. The growth section has at least one inlet in the flow path for receiving nanocrystal nuclei or nanocrystals and nanocrystal forming reagent fluid and at least one growth section outlet in the flow path for removing conditioned nanocrystal reagents or product nanocrystals in a carrier fluid from the growth section. The growth section inlet and outlet are capable of forming a fluid tight seal with one or more fluid delivery or receiving devices.

The flow path of the microfluidic module may include a growth termination section in which growth of the nanocrystals is terminated during a flow process. The growth termination section has growth termination channel length and cross section and can include one or more controlled heat exchangers for conditioning a nanocrystal forming reagent to terminate growth and maintain the growth termination section at a growth termination temperature that may include but is not limited to a constant temperature or a gradient. The growth termination section may include one or more mixing structure in the flow path. The growth termination section has at least one inlet in the flow path for receiving nanocrystals in a reagent fluid and at least one growth termination section outlet in the flow path for removing nanocrystals in a carrier fluid from the growth termination section. The growth termination section inlet and outlet are capable of forming a fluid tight seal with one or more fluid delivery devices.

The flow path of the microfluidic module may include a purification section in which separation of nanocrystals occurs during a flow process. In the purification section, phase separation or exchange of fluids containing nanocrystals from fluids occurs during a flow process. The purification section has a purification channel length, a cross section, a separation device in contact with in a length of channel in the flow path, and can have one or more heat exchangers for purifying a nanocrystal forming reagent and maintaining the purification section at a purification temperature, that may be a constant temperature or a gradient. The purification section has at least one inlet in the flow path for receiving nanocrystals in a reagent fluid, a separation device which can be but is not limited to a membrane or mechanical separation device for separations, a method and devices for waste fluid removal, and at least one purification section outlet in the flow path for removing nanocrystals in a carrier fluid from the purification section. The flow path in the purification section may have one or more mixing structures. The purification section inlet and outlet are capable of forming a fluid tight seal with one or more controlled fluid delivery devices.

The flow path of the microfluidic module may include a ligand exchange section in which ligand exchange from the surface of the nanocrystals occurs during a flow process. The ligand exchange section has a ligand exchange length, a cross section, and can include one or more controlled heat exchanger for conditioning a nanocrystal forming reagent to effect ligand exchange and maintain the ligand exchange section at a ligand exchange temperature that can be but is not limited to a constant temperature or a gradient. The ligand exchange section may have one or more mixing structures in the flow path. The ligand exchange section has at least one inlet in the flow path for receiving nanocrystals in a reagent fluid and can have one or more ports in the flow path for adding an exchange fluid to the nanocrystals in the reagent fluid. The ligand exchange section has at least one ligand exchange section outlet in the flow path for removing nanocrystals in a fluid from the ligand exchange section. The ligand exchange section inlets and outlet(s) are capable of forming a fluid tight seal with one or more controlled fluid delivery or receiving devices.

The flow path of the microfluidic module may include a coating section in which a coating is formed on a stabilized nanocrystal in a flow process. The coating section has a channel length and cross section and can includes one or more controlled heat exchangers for conditioning a nanocrystal reagent to form a coating on nanocrystals and to maintain the coating section at a coating temperature that can be but is not limited to a constant temperature or a temperature gradient. The flow path in the coating section can have one or more mixing structures in the channel and one or more ports along the flow path for addition of coating reagents to the channel. The coating section has one or more inlets in the flow path for receiving nanocrystals and at least one coating section outlet in the flow path for removing nanocrystals in a carrier fluid from the coating section. The coating section inlets and outlet(s) are each capable of forming a fluid tight seal with one or more fluid delivery devices.

The microfluidic module or sections within a module may have one or more ports in the flow path for addition or removal of one or more reagents from the flow path. The one or more ports can be located between the inlet and outlet of the flow path. Preferably the ligand exchange or purification section includes one or more ports in the section of the flow path for addition or removal of one or more reagents from the section. The one or more ports in these sections are located between the inlet and outlet of the section along the flow path or a manifold connected to the flow path. The controlled heat exchanger in any of the microfluidic modules may include at least one temperature sensor, pressure sensor, flow sensor and or pH sensor, at least one heat exchanger, and a controller interconnected in a feedback control loop. The controlled heat exchanger may include resistive elements or a channel with a temperature or flow controlled exchange fluid. Preferably the microfluidic module includes mixing structures such as but not limited to islands or heaters for the purpose of thermal, time, and temperature equalization of the fluid in the channel. Optical excitation in the deep blue or UV spectrum and optical sensors in the visible or infrared spectrum may be used for monitoring the size of nanocrystal nuclei or nanocrystals in the flow path or a section of the flow path. The flow path of the microfluidic module may include one or more inlets and or one or more outlets. The microfluidic module may include at least one valve in the flow path for regulation of fluid flow within the flow path.

A microfluidic reactor or system includes a flow path having one or more fluidly connected microfluidic modules for making nanocrystals products such as but not limited to nuclei, core, core/shell, coated core, ligand exchanged, or coated/core shell nanocrystals or conditioning nanocrystal forming fluids such as but not limited to separation, ligand exchange, coating or combinations of these. In a flow process, the flow path in each module is a channel formed in a first substrate and enclosed by a second substrate, or a channel formed partially in each of the first substrate and in the second enclosing substrate. The channel is in thermal contact with one or more independently controlled heat exchangers along the flow path for conditioning a nanocrystal forming reagent fluid in the flow path. Each module in the flow path has an inlet in the flow path for receiving the reagent fluid and an outlet in the flow path for removing conditioned reagent fluid from the module. The flow path in the module may have one or more mixing structures in the channel. Each module inlet and outlet is capable of forming a fluid tight seal with one or more fluid delivery devices. Where the microfluidic modules have one or more fluid inlets, outlets, or a combination of these, a microfluidic reactor assembled from them will have one or more flow paths. To form multiple flow paths the microfluidic modules can be connected in parallel, series, or a combination of these. A microfluidic module in the reactor may include multiple sections such as but not limited to a nucleation section, a growth section, a growth termination section, a purification section, a coating section, or a ligand exchange section or a combination of these. Preferably the microfluidic modules have a channel that includes one or more mixing structures.

A method of making nanocrystals using microfluidic modules or reactors includes conditioning one or more nanocrystal forming reagents, preferably fluorescent nanocrystal forming reagents in a flow path. The flow path includes one or more fluidly connected microfluidic modules for making a nanocrystal and preferably a fluorescent nanocrystal product in a flow process. The flow path in each module is a channel formed at least in a first substrate and enclosed by a second substrate and having mixing structures therein such as convection or mixing islands. The channels in the modules are in thermal contact with one or more independently controlled heat exchangers along the flow path to condition the nanocrystal forming reagents in the flow path. Each module has an inlet in the flow path for receiving the nanocrystal forming reagent fluid and an outlet in the flow path for removing conditioned reagent fluid from the module. Each inlet and outlet in the module is capable of forming a fluid tight seal with one or more controlled fluid delivery devices. A portion of the flow path may be monitored to measure a detectable property of a nanocrystal, and preferably a fluorescent nanocrystal product or reagent in the portion of the flow path. Based upon the measured property and its relationship to a predetermined range or setpoint for the property (feedback), the controllable temperature, fluid delivery device, reaction time, or a combination of any of these can be adjusted to maintain the detectable property of the fluorescent nanocrystal product in a pre-determined range. A further method of making nanocrystal particles employs ultraviolet optical energy applied in the area of a desired chemical reaction in order to promote photochemically-induced reactions in order to reduce or eliminate the need for thermally induced reactions.

### DESCRIPTION OF THE DRAWINGS

In part, other aspects, features, benefits and advantages of the embodiments of the present invention will be apparent with regard to the following description, appended claims and accompanying drawings where:

FIG. 1A is an illustration of a non-limiting example of a continuous flow nanocrystal growth microreactor module. Reagent fluids can be added to the reactor through one or both of ports 104 and 106. Heaters 158, 162, and 166, provide thermal preconditioning as the reagent fluids enter the micro reactor. The heaters, connected to bond pads located in open areas in the capping layer at 156, 160, 164, and 168 can make electrical connections with instrumentation. The initial mixing point of the nanocrystal forming reagents 110 is shown and may be realized with isotropic etching in silicon that can be made in a few fixed geometries or alternatively with deep reactive ion etching (DRIE) technique that can provide unlimited channel shape options since flexible (i.e. curvilinear) design rules can be utilized. Other heaters 152 can be fabricated along or in the channel, as well as sensors, 154. Electrical connections can be made to the outside edge of the reactor, 138, 140, 142, 144. The module can have sections etched out of the substrate to aid in thermal isolation, as in 114, 118, 124, 126. A thermal recovery section can be included in the pathway to recover the growth temperature of a reaction after crystal nucleation as illustrated with a fluid loop heat exchanger 112. Additional ports, 120, 132, 134 can be added along the channel for addition or removal of solvents, coordinating ligands or other reagent material. A growth flow path 116 can be incorporated to uniformly grow the nanocrystals to the desired size after nucleation. A fluid sealable output port 122 can be incorporated into the module. FIG. 1B is a cross section B-B down the center of FIG. 1A and additionally shows a construction of the module including a bottom glass substrate, 146, a top glass substrate 152, and a silicon substrate, 148. FIG. 1C is a cross section C-C through two thermal isolation voids, 124 and 126. In addition, sensor 152 and heater 154 are shown in close proximity to thermally isolated channel 116. Bottom glass substrate 146, top glass substrate 150 and the anodically bonded silicon wafer 148 are also shown.

FIG. 2A is a non-limiting illustration of nanoparticle purification and/or ligand exchange microfluidic module, 200. These modules enable the exchange of one liquid for another without losing particles or causing flow bottlenecks. The module includes a substrate 214, fluid sealable inlet 210 located at the entry to the module and port 230 located along the fluid channel 244. Flow can be reversible in paths 240, 244. Solvent and/or ligand injection ports 232, 234, 236, 238 attached by a plenum 240 are used to pass fresh solvent into the reactor, aiding in purification. Ports such as 230, 260 can be used to remove the excess solvent as well as input fresh solvent. FIG. 2B depicts a cross section of FIG. 2A, B-B, incorporating a polymeric porous membrane 262 sealed separating channels 220 and 244 having nanocrystal rich flow and solvent-rich flow, respectively. Rinsing or coordinating solvents can be flowed parallel or counter to the nanocrystal-rich reagent, entering through, for example, fluid sealable port 260. The illustration in FIG. 2C depicts a filter membrane composed of microporous and/or nanoporous elements, 246 fabricated in a semiconductor substrate 248 and anodically bonded to a second semiconductor substrate 250, each with incorporated flow paths, in order to aid in the exchange of solvents and/or ligands while retaining the maximum yield of nanocrystals. A blanket heater of transparent In/Sn oxide 258 is shown on the outside of the capping layer with electrical contacts 256. Semiconductor membrane 246 may be made of a material such as germanium, or coated with germanium, which upon application of a voltage (power supply and leads not shown) across surfaces 270 and 272 changes from hydrophobic to hydrophilic characteristics to aid in controlling fluid mixing.

FIG. 3 illustrates non-limiting examples of rapid reaction mixing structures which may variously be incorporated into the flow path of any microfluidic module of the present invention, in particular in an initial nanocrystal nucleation module or a core/shell formation module. FIG. 3A shows an example rapid reaction mixer method using deep reactive ion etching (DRIE) into silicon, glass, or utilizing molded polymers. Two fluids are input through flow paths 302 and 306 and transported to multiple flow sub-channels at 304 and 308 respectively before rapidly combining at 316. Heaters 330 and sensors 320 can be used to control the temperature of the reaction in a feedback loop. Islands 312 in the flow path 310 can be fabricated using the DRIE technique to ensure good thermal and/or chemical mixing of the fluids. FIG. 3B shows another example rapid reaction mixer in which two fluids are mixed. One fluid is introduced through fluid sealable port 104, and travels through channel 332. Another fluid is introduced through fluid sealable port 106, traveling through channel 336. Mixing islands can be fabricated into channels 332 and 336. Nanoporous, mesoporous or macroporous membranes 338, or a combination of such pore sizes, are shown for injecting fluid in multiple small streams into cavity 110 to ensure rapid thermal/chemical mixing as the solutions are combined before flowing into the channel 116. FIG. 3C shows a cross section of FIG. 3B. The porous membranes, showing as islands 338, confining the mixing cavity 110 can be fabricated from, for example, silicon wafers, 344, 346. Silicon wafer 148 can be etched to provide output channel 116. Silica glass plates 146, 150 can be bonded to the outsides of the silicon wafers, and the silicon wafers can be bonded to each other using conventional anodic bonding techniques. FIG. 3D shows an illustration of a rapid reaction mixer 346 method using isotropic wet etching in a single layer of silicon to form channels 350, 352, 354, islands, 342, 340, and protrusions, 344, all of which aid in thermal and/or chemical mixing. Input channels can be made wider, 350 that other input channels, 352 to balance pressure differences between reagent fluid flows. Heaters and/or sensors, 356 can be incorporated to control the temperature of the reaction. FIG. 3E shows an illustration of a linear reaction mixer 358 with channel 368 and mixing obstructions 366. Heaters 362 and 364 or temperature sensors can be included in close proximity to the channel to control heat the reaction by providing a constant temperature or to induce a convection mixing gradient across the channel.

FIG. 4 shows a non-limiting example of sealable port and module-joining method employing a flow path and/or inlet and outlet port with external functional accessories for use in joining metal needles to ports 104, 106, 132, 134, 120, and 122 as shown in the FIG. 1A microfluidic module. A seal-forming barrier, for instance a rubber septum 412 can be fixed to silicon dioxide wafer 414 by adhesive, a press fit or a compressing fitting. Capping wafer 414 can be bonded to flow-path-containing wafer 416 anodically or using adhesive or glass frit, for example.

FIG. 5A shows a non-limiting example growth channel mixer fabricated using deep reactive ion etching. Arrow 526 shows the average fluid movement direction and the black arrows 518 show the local fluid movement in the channel 520 due to the islands 524. FIG. 5B shows an illustration of a growth channel mixer based on thermal mixing which can create circular mixing motion 512 in the channel 502 using heaters, 504 with integrated, in-stream temperature sensors. The average fluid flow is in the direction 514.

FIG. 6A shows an example optical feedback particle size control method using broad area ultraviolet (UV) excitation 616 or a laser of a specific wavelength focused to a small spot 624 and visible radiation signal acquisition detectors 620 and 626. Other size control methods are possible. FIG. 6B illustrates optical feedback particle size control method using fiber optic point excitation paths 662, 660, 658, 656 and visible light signal acquisition 672 along the fiber 660 joined by a coupler to the laser or bulb excitation source 670. A combination of broad area excitation and point signal acquisition may also be appropriate in certain implementations. Ultra violet source 666 can be used to induce photochemical reactions through a suitably transparent flow channel covering, especially in nucleation sections such as FIG. 3A-3D.

FIG. 7 is a non-limiting illustration of a microfluidic reactor column for the production of fluorescent nanoparticles. The reservoirs can be, for instance, syringe pumps and/or expandable accordion-type fluorpolymer vessels and can be much larger in scale than individual reactor modules. Reservoir 710 and 712 are joined to a microfluidic module 102 comprised of the pre-conditioning section, 714, the nucleation section, 716, the temperature recovery section 112, the growth section 718, and the termination section 720. The nanocrystal-containing reagent fluid is fed into two or more parallel and substantially identical purification modules, 200. A reservoir with solvent for purifying the nanocrystals, 722 is attached to each of the purification modules 200 by a valve manifold allowing flexible management of fluid flow. A reservoir 724 with coordinating ligands for exchange with the initial ligands surrounding the nanocrystals is attached to each of the purification modules 200 by a valve manifold. A waste reservoir 726 is attached to the purification modules 200 by a valve manifold. The manifold allows fluid communication between reservoirs and modules 200 as needed. A reservoir 728 with reagent fluid used in coating nanocrystals is attached to the fluid stream exiting the purification sections using a valve manifold or alternatively into an input port in module 730. Reagent fluid is pumped through module 730 comprised of pre-conditioning section, a coating growth section, and a termination section. The fluid is divided through parallel purification and ligand exchange modules 740. Reservoirs with solvent for purifying the nanocrystals, 732 and buffered solutions of coordinating ligands, 734 are attached to each of the purification modules 740 by a valve manifold. A waste reservoir 736 is attached to each of the purification modules 740 by a valve manifold. The manifold allows fluid communication between each reservoir, 732 and 734 and each of the two modules 740. A stabilized crystalline product is obtained but can be further processed in-stream by additional, substantially similar microreactor modules for the purposes of functionalizing the nanocrystals for water solubility and/or their attachment to other entities as in biological uses.

FIG. 8 is a schematic illustration of a microfluidic reactor columns made by interconnecting microfluidic modules (single channel) for the production of fluorescent nanoparticles. The microfluidic modules are shown having one or more inlets, outlets, and ports for the transfer of nanocrystal forming reagents into and out of the flow path. The microfluidic reactor column has modules in parallel forming two flow paths at various stages in the column.

### DETAILED DESCRIPTION

Before the present compositions and methods are described, it is to be understood that this invention is not limited to the particular molecules, compositions, methodologies or protocols described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “nanocrystal” is a reference to one or more nanocrystals and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

Embodiments of the present invention include forming monodisperse nanocrystalline materials in a continuous flow process in one or more connected microfluidic modules. A continuous flow process is one in which reactants are fed into a microfluidic module, containing one or more functional sections, continuously for periods of time and product nuclei, nanocrystals, or coated nanocrystals formed in one or more sections or modules are removed from an outlet of one microfluidic module and into the inlet of another until the desired degree of completion of the nanoparticles is reached. Nanocrystals formed in batch reactors may be fed into the inlet of any microfluidic module and processing of the nanocrystals continued using the microfluidic modules.

The nanocrystals of a particular size made by the system may have a distribution of sizes. Preferably the size distribution at one standard deviation is less than about 5% of the average nanocrystal size; for fluorescent nanocrystals the distribution of size is such that the fluorescent optical spectrum is preferably less than 50 nm full width at half maximum (FWHM), more preferably less than 35 nm, and even more preferably less than 28 nm. The term “monodisperse”, when describing particles denotes a population of particles of which a major portion, typically at least about 60%, more preferably from 75% to 90%, fall within a specified particle size range. A population of monodisperse particles deviates less than 10% rms (root-mean-square) in diameter and preferably less than 5% rms. In addition, upon exposure to a primary light source, a monodisperse population of semiconductor nanocrystals is capable of emitting energy in narrow spectral linewidths, as narrow as which is preferably less than 50 nm full width of emissions FWHM, and with a symmetric, nearly Gaussian line shape. As is known to those skilled in the art, the size of the core of the semiconductor nanocrystal correlates with the spectral range of emission and the linewidths are dependent upon, among other things, the size homogeneity, i.e., monodispersity, of the semiconductor nanocrystals in each preparation.

One or more microfluidic modules may be combined to form a microfluidic reactor which can be used for preparing nanocrystals wherein the nanocrystals are an ordered array of atoms without internal grain boundaries, preferably the core nanocrystals are crystalline with an average size in the range of about 1 nm-500 nm but preferably from 1 nm to 10 nm. Organometallic and metal-organic reactions are known for the production of metal nanoparticles, including, for example gold nanoparticles. Another metallic nanoparticle forming nanocrystal preparation is disclosed in U.S. Pat. No. 6,262,129, the contents of which are incorporated herein by reference in their entirety. Fluorescent nanocrystals refer to nanocrystals comprising semiconductor nanocrystals or metal oxide nanocrystals, or doped variations of either, to which may be operably bound various ligands. Semiconductor nanocrystals refer to quantum dots that have a core comprised of at least one of a Group II-VI semiconductor material (of which ZnS, HgS, CdSe, and CdTe are illustrative examples), or a Group III-V semiconductor material (of which GaAs is an illustrative example), or a Group IV semiconductor nanocrystal, or a combination thereof. These core semiconductor nanocrystals may further comprise and be passivated with a “shell” or capping layer of material uniformly deposited on the core. The material may be comprised of an inorganic material shell coating with a higher band gap than the core nanocrystal. An illustrative, non-limiting example of inorganic materials typically used to thus passivate CdX (X═S, Se, Te) core nanocrystals are preferably comprised of YZ where “Y” is Cd, Hg, or Zn and “Z” is S, Se, or Te. Core CdX nanocrystals with a YZ shell as disclosed in U.S. Pat. No. 6,322,901 the contents of which are hereby incorporated by reference in their entirety. An illustrative example of a doped semiconductor nanocrystal is CdSe:Mn (reference: F. V. Mikulec, M. Kuno, M. Bennati, D. A. Hall, R. G. Griffin, M. G. Bawendi, J. Am. Chem. Soc. 2000, 122, 2532-2540). Doped metal oxide nanocrystals refer to nanocrystals comprised of a metal oxide, and a dopant, comprised of one or more rare earth elements or transition metal elements. For example, metal oxides include, but are not limited to refractory metal oxides such as titanium dioxide, TiO₂, aluminum oxide, Al₂O₃, yttrium oxide (Y₂O₃), zirconium oxide (ZrO₂), zinc oxide (ZnO), copper oxide (CuO or Cu₂O), gadolinium oxide (Gd₂O₃), praseodymium oxide (Pr₂O₃), lanthanum oxide (La₂O₃), and alloys thereof. Metal oxide nanocrystals can be doped with rare earth elements, including, but not limited to, those elements selected from the Lanthanide series such as europium (Eu), cerium (Ce), neodymium (Nd), samarium (Sm), terbium (Tb), gadolinium (Gd), holmium (Ho), thulium (Tm), and alloys containing these elements. A non-limiting example is Y₂Fe₅O₁₂:Nd. A non-limiting example of a doped metal oxide with a transition metal is alumina doped with chromium, Al₂O₃:Cr. Other transition metal dopants include, but are not limited to Mo, W, Mn, Fe, Co, Ni, Nb, and Ta. As known to those skilled in the art, depending on the dopant, an energized doped metal oxide nanocrystal is capable of emitting light of a particular color. A given rare earth or rare earth metal combination in a doped metal oxide has a given color. By adjusting the nature of the dopant and or the concentration of the dopant, the doped metal oxide nanocrystals may emit (with a narrow emission peak) a color over an entire range of colors. For example, the emission color and brightness (e.g., intensity) of a doped metal oxide nanocrystal comprising Y₂O₃:Eu may depend on the concentration of the Eu dopant; e.g., emission color may shift from yellow to red with increasing Eu concentration. Methods for making doped metal oxide nanocrystals are known to include, but are not limited to a sol-gel process (see, e.g., U.S. Pat. No. 5,637,258), a metal-organic reaction, and an organometallic reaction. As will be apparent to one skilled in the art, the dopants (e.g., one or more rare earth elements) are incorporated into the doped metal oxide nanocrystal in a sufficient amount to permit the doped metal oxide nanocrystal to be put to practical use in, for example, fluorescence detection. Preferably the amount of dopant in a doped metal oxide nanocrystal is an atomic amount in the doped metal oxide nanocrystal selected in the range of from about 0.1% to about 25%. Doped metal oxide nanocrystals may be excited with a single excitation light source resulting in a detectable fluorescence emission of high quantum yield (e.g., a single nanocrystal having at a fluorescence intensity that may be a factor of ten or more greater than that of a molecule of a conventional fluorescent dye) and with a discrete fluorescence peak. Typically, doped metal oxide nanocrystals have a substantially uniform size of less than 20 nm, and preferably have a substantially uniform size in the range of sizes of from about 1 nm to about 5 nm. The doped metal oxide may have both fluorescent properties (when excited with an excitation light source) and magnetic properties.

For purposes of the specification and claims of the present invention, the term “conditioning” a reagent fluid denotes chemically reacting the reagent or modifying its physical condition and/or chemical composition. This may include, but is not limited to, heating or cooling the reagent to a constant temperature, heating or cooling the reagent in a temperature gradient, performing solvent exchange with the reagent, purifying the reagent to remove particles, ions, or molecular contaminants, particle size sorting by filtration or size selective precipitation, formation of nanocrystal nuclei, particle growth, growth termination, capping layer growth, functionalization, or mixing of two or more reagents or fluids. Conditioning may also include a temperature recovery section in the flow path in which the thermal condition resulting from either an endothermic or exothermic reaction is rapidly recovered to a desired next reaction temperature for the suppression of side reactions and improving the control of nanocrystal or nanocrystal nuclei size distribution.

A nanocrystal forming reagent fluid for purposes of the specification and claims refers to fluids which may include solvent or mixtures of solvents, dispersed, solvated, or flocculated nanocrystals, nanoparticles, and preferably fluorescent nanocrystals in solvents, and reagents used in the preparation and coating of nanocrystals, nanoparticles, or fluorescent nanocrystals. In the specification and claims of the present invention the terms nanoparticles and nanocrystals are used interchangeably. The nanocrystal forming reagents may be from another microfluidic module, a microfluidic reactor, or a batch process. The nanocrystal forming reagents may be but are not limited to those used for nucleating, growing, solvent exchange, purification, and coordination/stabilization of nanocrystals, nanoparticles, and preferably fluorescent nanocrystals. The reagent fluid can include but is not limited to liquids and gases, coating reagents such as but not limited to organosilanes, mercaptoacetic acids, amino acids, peptides, and monomers for oligomeric or polymeric coatings, solvents, exchange ligands, nanocrystal nuclei in solvents, nanocrystals in a solvent, functionalized nanocrystals or combinations of these. A carrier fluid can be a coordinating solvent, an organic solvent; or an aqueous solution for suspending or dispersing nanocrystals or nanocrystal nuclei. Preferably the reagent fluid and carrier fluid are used for making fluorescent nanocrystals.

For purposes of the present invention, any nanocrystal-containing reagent from a batch process, vapor phase generated particles, or those from other microfluidic reactors may be fed into post-growth processing microfluidic modules of the present invention to provide the means to further size separate, purify the nanocrystals, exchange solvents, coat the nanocrystal cores with shells of inorganic materials, exchange ligands and/or coat with functional organic coatings in the desired order and for the desired number of times, in series and/or parallel flow modules, for the purpose of producing uncoated nanocrystals or nanocrystals coated to the desired number and types of coatings for their intended purpose.

Separation or purification may include but are not limited to size sorting, removal of solvent from dispersed or flocculated nanocrystals, sieving filtration, or solvent induced flocculation of the nanocrystals. Ligands include but are not limited to coordinating solvents, organic solvents, as well as molecules and polymers chemically bonded to a nanocrystal surface. Coatings for purposes of the present invention and claims include but are not limited to a shell of inorganic or organic material on a core or core/shell nanocrystal, ligand exchange of nanocrystals, organic coatings to make water soluble nanocrystals, organic coatings for bonding to living or dead cells or other molecules such as those disclosed in U.S. Pat. Pub. 20040009341 the contents of which are incorporated herein by reference in their entirety.

A fluorescent nanocrystal product is the material output from a microfluidic module or microfluidic column and that has conditioned a nanocrystal forming reagent and can include but is not limited to nanocrystal nuclei, nanocrystal core, nanocrystal core/shell, coordination ligand exchanged or chemically modified coated (core or core shell) nanocrystals or any of these dispersed or flocculated in a solvent fluid.

The chemistry used to make various nanocrystals in the microfluidic reactor comprised of one or more microfluidic module(s) of the present invention may be based on known batch process chemistries, but is not limited to said known batch chemistries (references: C. B. Murray, D. J., Norris, M. G. Bawendi, J. Am. Chem. Soc., 1993, 115(19), 8706-8715; U.S. Pat. No. 6,207,229 B1; U.S. Pat. No. 6,322,901B1; U.S. Pat. No. 6,576,291B2). For semiconductor nanocrystals, trioctylphosphine oxide, TOPO, trioctylphosphine, TOP, hexylphosphonic acid, HPA, tetradecylphosphonic acid, HDPA, and preferably TOPO/TOP solvent systems may be used for preparing semiconductor nanocrystals. The formation of high quality CdTe, CdSe, and CdS nanocrystals may also be made using CdO as a precursor, as is known in the art (references: Z. A. Peng, X. Peng, J. Am. Chem. Soc., 2001, 123, 183-184.; U.S. Pat. Pub. No. 20020066401). Examples of magnetic nanocrystals and nanoparticles such as colloidal sized particles of ferromagnetic iron oxide Fe₃O₄ coated with a water-soluble polysaccharide and having pendant functional groups are disclosed in U.S. Pat. No. 4,452,773 incorporated herein by reference in its entirety and magnetic Fe/Pt alloy nanoparticles disclosed in U.S. Pat. No. 6,302,940 and incorporated herein by reference in its entirety may be prepared using the microfluidic modules and reactors of the present invention.

In the preparation of various nanocrystalline materials, a short nucleation step followed by a longer slower growth step aids in the formation of nanocrystals having a narrow size distribution. Nucleation may be achieved by rapidly mixing reagents into a heated coordinating solvent to induce supersaturation and nuclei formation or by premixing the reagents in a coordinating solvent and using a controlled ramp or sharp step in temperature to create supersaturation and nuclei formation. The nucleation section of the flow path is that portion of channel in which the formation of nanoparticle nuclei is initiated. The size distribution of nanocrystal nuclei may be controlled by minimizing the time-temperature product in which nuclei form and grow. Growth of nanocrystals to a final size and in a narrow size distribution can also occur under reaction conditions which avoid supersaturation and include adjusting temperature, reagent concentration, choice or reagent reactivity, use of surfactants, and time of reaction. Generally higher concentrations and longer growing times result in larger nanocrystals.

Terminating the growth of nanocrystals may be accomplished by cooling the growth solution. Preferably molecules coordinated to the surface of the nanocrystals stabilize them, allowing the nanocrystals to remain dispersed in a stabilized solution when cooled. The termination of the nanocrystal growth conditions to effect termination of crystalline growth may include but is not limited to decreasing the temperature of the nanocrystals (sol) in the growth termination path, removing excess reagent, or adding a reaction-terminated nanocyrstal capping reagent.

The stable, growth-terminated nanocrystal dispersion-containing solution may be treated with a non-solvent to isolate powdered nanocrystals by flocculation and filtration. Alternatively the stable, growth-terminated nanocrystal dispersion-containing solution may be titrated with a non-solvent to cause partial flocculation and allow isolation of larger nanocrystals by separating them from the solution by for example, but not limited to filtration or other means. Repeated titration and separation may be used to narrow the distribution of nanocrystals in the solution.

The surfactant or organic layer on the growth-terminated nanocrystals may be partially or completely exchanged for other coordinating molecules such as Lewis bases of which an non-exclusive example is pyridine. For example, CdSe and other nanocrystallites are stabilized in solution by the formation of a lyophilic coating that may consist of alkyl groups on the crystallite outer surface. The alkyl groups are provided by the coordinating solvent used during the growth period. The inter-particle repulsive force introduced by the lyophilic coating prevents aggregation of the particles in solution. (reference: M. L. Steigerwald, A. P. Alivisatos, J. M. Gibson, T. D. Harris, R. Kortan, A. J. Muller, A. M. Thayer, T. M. Duncan, D. C. Douglass, L. E. Brus, J. Am. Chem. Soc., 1988, 110(10), 3046-3050. Gradual addition of a non-solvent will lead to the size-dependent flocculation of the nanocrystallites. Suitable non-solvents include low molecular weight alcohols such as methanol, propanol and butanol. Size dependent flocculation may be used to further narrow the particle size distribution of the nanocrystallites by a size-selective precipitation process. Upon sequential addition of a non-solvent, the largest particles can be made to be the first to flocculate. The removal of flocculated particles from the initial solution results in the narrowing of the particle size distribution in both the precipitate and the supernatant.

One or more inorganic coating layers or shells may be deposited onto nanocrystals. Preferably the layer is epitaxially grown and each coating layer has a higher band gap than the core nanocrystal or any preceding layers. Inorganic coating layers formed on nanocrystals are preferably grown under heterogeneous conditions using low reactant concentrations. For example, the coating layer may be grown onto nanocrystals prepared by a microfluidic module(s) in a microfluidic reactor system and fed as a mixture with a coordinating solvent and layer-forming reagent directly into the inlet of a microfluidic module(s) having a growth section. The coating layer may also be grown on nanocrystals dispersed in a coordinating solvent that is dispensed along with layer forming reagents into the inlet of a microfluidic module(s) having a growth section. The coated nanocrystals may be solvent exchanged, purified and isolated, or may be coated with molecules having functional groups for other applications. The ratio and concentration of reagents to form a coating layer of a desired thickness on the nanocrystal and maintain heterogeneous conditions can be determined from the coating density, lattice parameters of the coating material, as well as the size of the nanocrystals.

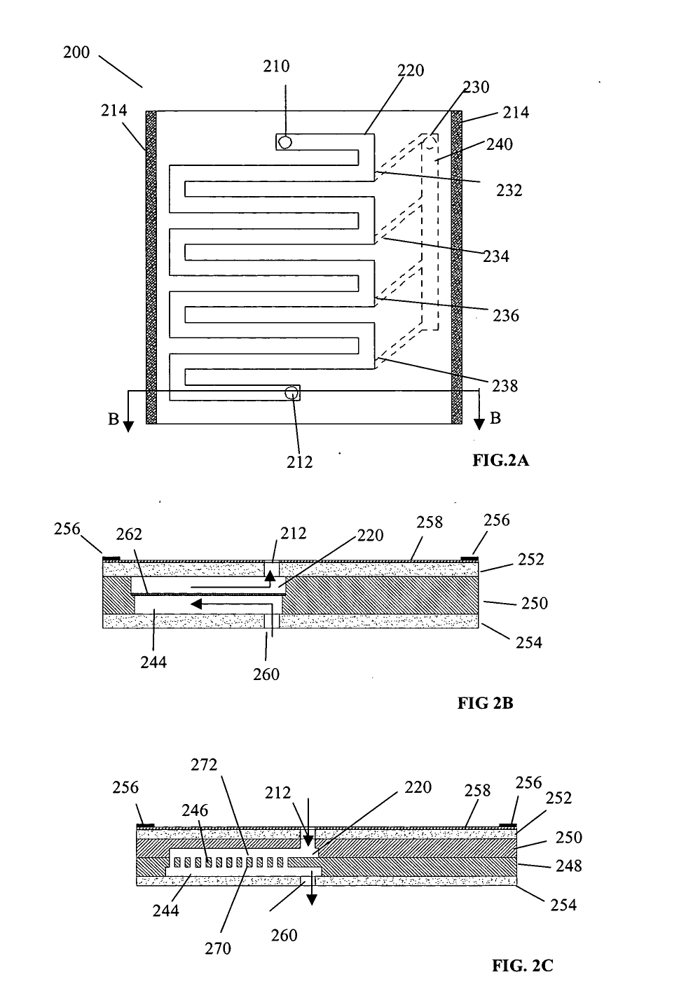

Organic capping layers may be formed on the nanocrystals, and in the case of semiconductor nanocrystals can be formed on core nanocrystals or nanocrystals with an inorganic coating shell layer. As a non-limiting example, nanocrystals can be prepared which are water soluble. (CdSe)/ZnS core/shell nanocrystals passivated with pyridine can be exchanged with a capping compound which contributes to the water-solubility of the resultant nanocrystals. For example, a capping compound comprising a mercaptocarboxylic acid may be used to exchange with the pyridine overcoat. Exchange of the coating group could be accomplished by treating the water-insoluble, pyridine-capped quantum dots with neat mercaptocarboxylic acid in a module illustrated in FIG. 2. Pyridine-capped (CdSe)ZnS quantum dots can be precipitated in the flow path 220 with hexanes added through port 230, and then isolated by filtration with membrane 262. Hexane and pyridine can be removed from the flow channel through port 260. The nanocrystal residue on the membrane may be dissolved in neat mercaptoacetic acid, with a few drops of pyridine added to the port 230, if necessary, to form a transparent solution. The solution may be allowed to stand at room temperature in the flow path for about six hours to complete the exchange the of mercaptocarboxylic acid for pyridine on the nanocrystal surface. Chloroform can be added to precipitate the nanocrystals and wash away excess thiol. The capped nanocrystals may be isolated by filtration, washed as necessary with chloroform, and then washed with hexanes. The residue may be briefly dried with a stream of inert gas. The resultant nanocrystals, coated with the capping compound, are then soluble in water or other aqueous solutions. Other coatings forming water soluble and functionalized nanocrystals include those disclosed in U.S. Pat. No. 6,468,808, U.S. Pat. No. 6,114,038, U.S. Pat. Pub. No. 20040009341 A1 and U.S. Pat. Pub. No. 20030059635A1 the contents of each are incorporated herein by reference in their entirety.

Where necessary, size dependent flocculation may be used in a purification microfluidic module(s) to narrow the distribution of particle sizes. In a non-limiting example, nanocrystals formed in a continuous flow or batch process may be provided to the fluid inlets 210 and 260 of a purification section or module illustrated in FIGS. 2A and 2B. Non-solvent may be introduced into or removed from the channel 244 through port 230. The non-solvent may enter the channel 220 including the nano-crystals in a crystal-coordinating solvent 210 and flocculant and/or ligand exchange reagents can enter through port 260 or the various points 232, 234, 236, 238, in the manifold 240, and by reversing the flow via valving (not shown), waste can be removed from the same ports. Flocculated nanocrystals may be precipitated onto the inner surface of 254 by flocculation and nanocrystals may be removed by exchange with a coordinating solvent such as pyridine from, for example, port 212 as selected by valving and manifolds in the flow path. The outer surface of the nanocrystal includes an organic layer derived from the coordinating solvent used during the capping layer growth process. The crystallite surface may be modified by repeated exposure to an excess of a competing coordinating group. In a non-limiting example, a dispersion of CdSe nanocrystals having a surface layer of TOPO/TOP coordinating ligands may be treated with a coordinating organic compound, such as pyridine, to produce crystallites which disperse readily in pyridine and aromatic solvents but can no longer be dispersed in aliphatic solvents. Such a surface exchange process may also be carried out using a variety of compounds which are capable of coordinating or bonding to the outer surface of the capped quantum dot or nanocrystal, such as by way of example, Lewis bases, phosphines, thiols, amines, amides, and phosphates. Mixing in this module(s) may be performed by mixing structures or convective heating at a controlled temperature, preferably below 100° C., at a system flow rate to maintain the particle size and desired size distribution. A non-limiting example of a ligand exchange module is shown conceptually in FIG. 2.

The purification microfluidic section(s) or module(s) can be used to increase the efficiency of the exchange of one ligand for another by creating a stress on the equilibrium reaction through the removal of more of the bound TOPO (Le Chatelier's principle). There is a distinct advantage to removing as much TOPO as possible since it can act as an impurity in subsequent reactions. Temperature sensors and heat exchange devices may be used in the ligand exchange microfluidic sections and module(s) for process control. The exchanged nanocrystals may be exposed to molecules and short chained polymers (oligomers) which exhibit an affinity for the nanocrystal surface at one end of the molecule or oligomer and which terminate in a moiety having an affinity for the suspension or dispersion medium. Such affinity improves the stability of the suspension and discourages flocculation of the exchanged nanocrystals.

The one or more inlets and outlets of the microreactor, or any of the microfluidic modules, the flow path, and individual sections of the microfluidic modules are each capable of forming fluid tight seals, if necessary. The fluid tight seals provide fluid connections between different microfluidic modules for making larger and more economical microfluidic reactors. Fluid tight seals are capable of maintaining an inert atmosphere for reagents and prevent loss of fluid from the flow path. Fluid tight seals may be used to join microfluidic modules separated by a valve, fluid buffer, an access point such as a septum, or a flow controller. The fluid tight seals with a conduit as shown in FIG. 4 are used to form a continuous flow path, which may be branched, and can include but are not limited to the use of cannulas or needles through septa, etched channels, fusion bonded perfluorinated hollow tubes, compression fitting tubing seals, or welded, adhesive, or anodic bonds.

Ports, locations for fluid interconnects and integration of component devices into modules can be designed to withstand 6.9×10⁵ N/m² (100 psi) pressure and 20 insertions of non-coring needles. Such ports may be made from silicone and other materials and blunt, pointed non-coring and side-perforated needles. Teflon™, glass, or other polymer nipples may be used for ports as well as septa. Ports may be prepared by sealing metal tubing in a glass using a glass-to-metal seal, reactively ion etching the ports, or isotropically etching the ports or ports can be made by drilling the glass substrate (when glass is the capping wafer). Interconnection can be accomplished by, but is not limited to using fused silica capillary tubing with polymer nipples or stainless steel tubing.

A detectable property of the nanocrystal or a reagent used to make or purify them may be used to adjust the system parameters and control processes such as nucleation, growth rate, growth termination, and purification. Preferably the detectable property can be measured on-line with sensors as nanocrystals are formed in the flow path of a module(s), reactor, or combination of reactors. Useful detectable properties include the FWHM of the fluorescent emission of fluorescent core and core shell nanocrystals, solvent composition, and absorption or generation of heat. The detectable property measured in a portion of the flow path may be compared to a reference value or setpoint. A change in the detectable property relative to the set point may be used to govern process parameters of a section, a microfluidic module(s), a reactor or a combination of reactors through a controller. For example, the controllable heat exchangers may be used to control flow path temperature, the controllable fluid delivery device (flow controllers, dispense pump or syringe, solvent addition, pressure pot pressure, metering valve), can be used to control the rate of flow or concentration of reagents fed into the flow path to adjust reaction rate and reaction time (length), or a combination of these can be adjusted to maintain the detectable property of the fluorescent nanocrystal product in a pre-determined range.

The microfluidic module or a reactor column including one or more interconnected modules may have one or more sensors for monitoring or determining the reagent fluid flow rate through the system at a desired point in the module or column. The flow rate may be used as part of an open or closed feedback control loop for modifying the temperature of the reactants or growth rate of the nanocrystals. Pressure or thermal sensors fabricated in the flow channel may be used to infer the flow rate from differential pressure or temperature differential readings. The one or more temperature sensors for monitoring temperature through the flow path and any section or point in the system can be used as an input for control of the system by means of a feedback control loop.

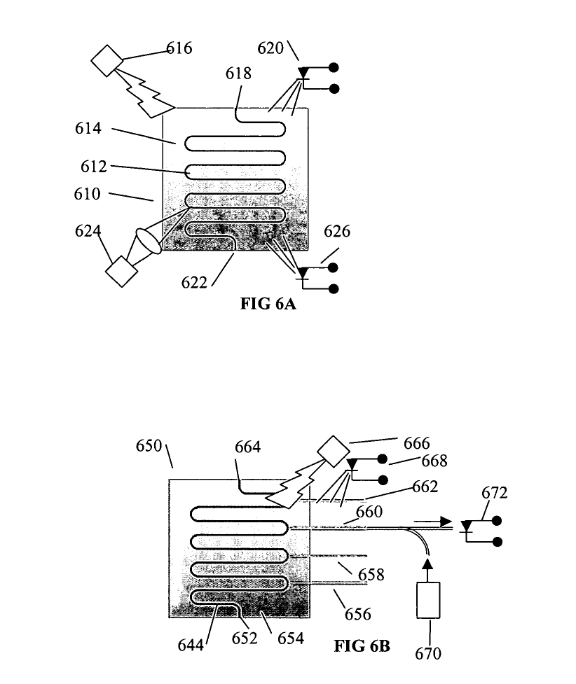

The microfluidic module(s), and/or reactor may include at least one UV light source such as but not limited to an ultraviolet bulb, a UV light emitting diode, UV light from a fiber optic, or a laser that operates in the range of 0.1 μm to 2 μm wavelength but preferably between 0.24 μm and 0.5 μm. The ultraviolet energy may be used to induce chemical reactions with nanocrystal forming chemical reagents, induce two photon reactions, or for monitoring a detectable property such as the fluorescent emission to determine the size of fluorescent nanocrystals. The ultraviolet light excitation may be applied for chemical reaction purposes with or without additional thermal control means. Where the optical excitation is used to monitor the size of fluorescent nanocrystals, the wavelength of light is such that it causes the forming nanocrystals to fluoresce. The one or more layers enclosing the channels in the substrate, or a port window, is transparent to the UV and visible light, for instance, high silica glass or fused quartz. As illustrated in a non-limiting example in FIG. 6A, the optical excitation from one or more sources 616 and 624 can be applied broadly over the face of the microfluidic module 610 or focused at one or more positions along the flow path 612 in substrate 614 having inlet 618 and outlet 622. A detectable signal as from the fluorescent emission from fluorescent nanocrystals in the flow path may be determined by one or more sensors 620 and 626. The signal from each sensor may be related to a property of the nanocrystals such as their size and used to adjust controlled fluid delivery devices or controlled heat exchangers (not shown) connected to the module(s). A comparison of the signals from the one or more sensors 620 and 626 may be used for example, to determine the amount of change in nanocrystal size, and to adjust controlled fluid deliver devices or controlled heat exchangers (not shown) connected to the module(s). As illustrated in FIG. 6B, optical excitation may also be applied by focusing the light mechanism or through one or more illustrative optical fibers 656, 658, 660, and 662 which may be positioned at one or more points along the flow path 644 in substrate 650 through passages between the module layers (not shown) or can be attached normal to the plane of the module layers over the flow path. The visible fluorescent emission from the excitation of the fluorescent nanocrystal can be detected by the same or different optical fibers positioned at various points along the flow path 644 with inlet 664 and outlet 652. The signal may be utilized for open or closed loop control of the microfluidic module(s) and reactor parameters such as but not limited to flow rate, flow channel fluid temperature, or fluid addition rate through the correlation between the nanocrystal sizes and their optical emission wavelengths.

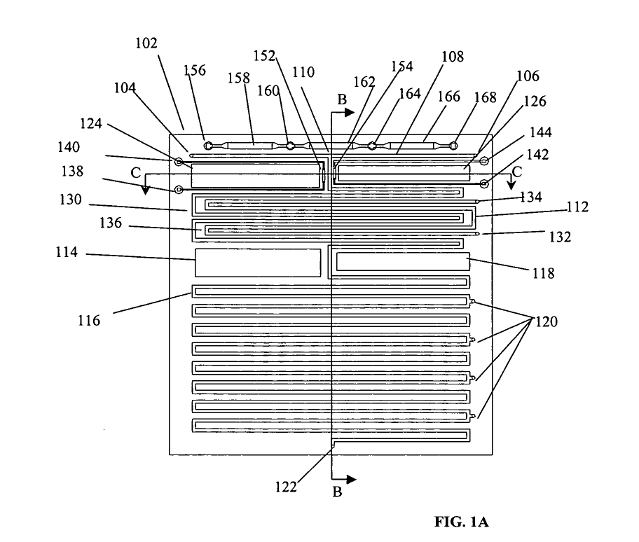

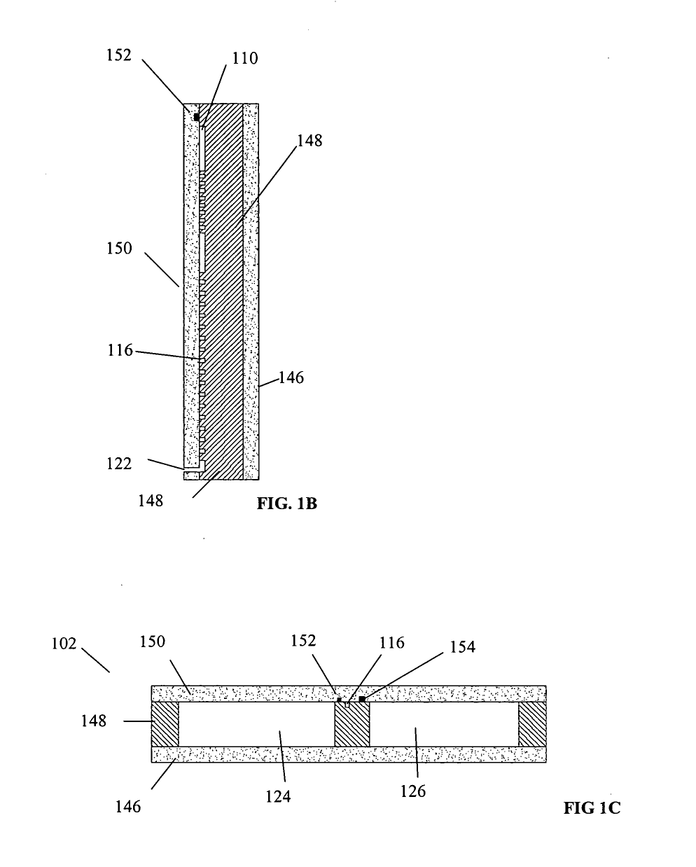

A controlled heat exchanger includes a heat exchanger, a temperature-measuring device and a temperature controller connected in a feedback control loop. A controller may be used to maintain the temperature of a portion of the flow path at a desired setpoint in a feedback control loop with a temperature-measuring device. Alternatively, the measured size, size distribution, or physical property of the nanocrystal stream is measured in line and temperature or flow rate, or both, controlled to adjust the process. The control loop may regulate the amount of current to a resistive heater or to control the pulse rate of one or more lamps or laser sources illuminating a portion of the flow path. A temperature sensor and control loop may be used to regulate the flow of an external source of temperature-controlled fluid, from a chiller for example, through a heat exchange conduit in contact with the flow path of the nanocrystal forming reagents. For example, as shown in FIG. 1, a heat exchanger conduit 112, with exchange fluid inlet 132 and exchange fluid outlet 134 may be made in the form of a channel in the substrate which is isolated from nucleation section flow path 130 by the substrate wall 136 and enclosed by bonding to a top layer 150. A fluid may be provided to the conduit 112 from an external source of heating or cooling fluid for heat exchange with nanocrystal forming reagents in the nucleation section flow path. Similar heat exchange structures may be formed in other parts of the module, or in other microfluidic modules of the present invention. For rapid control of the temperature of a nanocrystal forming reagent in a channel of a module the heat exchanger can include resistive heater elements or optical heating sources as from an infrared laser (not shown), in contact with the nucleation section flow path 110, a cooling fluid, gas or liquid, may be provided to exchanger conduit 112. One or more diode laser sources, lamps, or other optical energy sources may be positioned along the flow path of the module to condition, which includes but not limited to temperature control or inducing photochemical reactions, the nanocrystal forming reagents in the flow path The optical sources may be individually turned on and of or pulsed at varying rates by a controller to manipulate the energy delivered to the fluid. The heat exchange channel or other electrical temperature control devices can be provided on the back or front sides of a module(s) to shorten the thermal path.

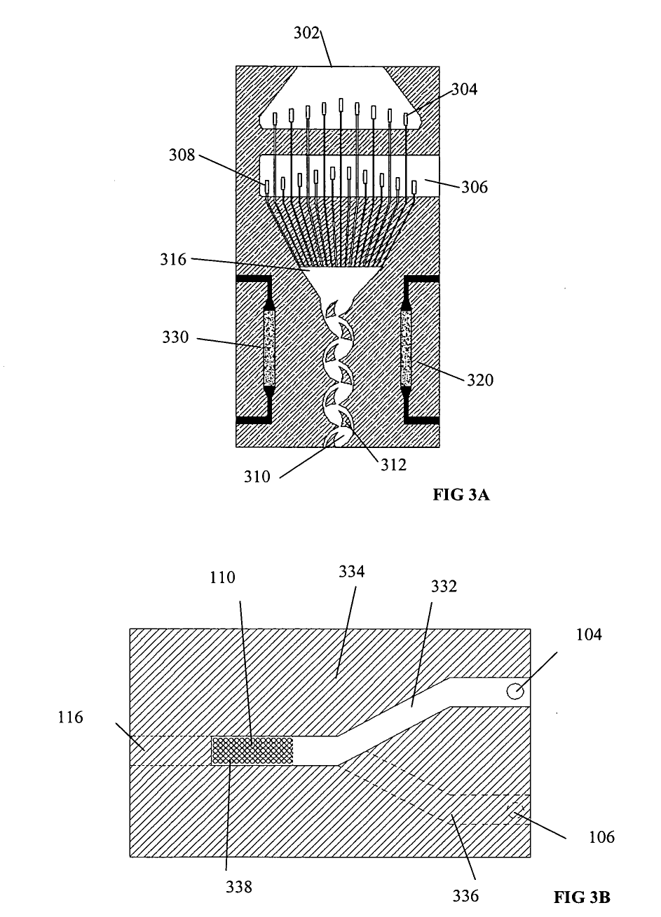

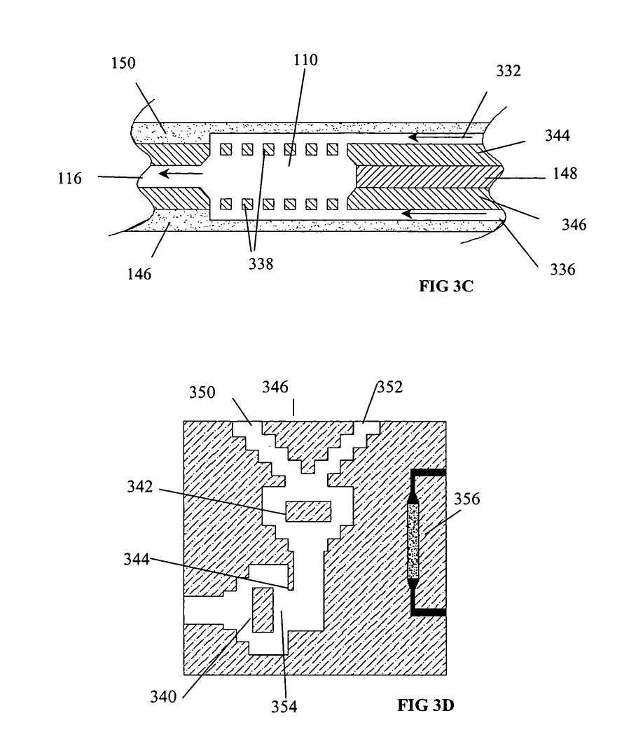

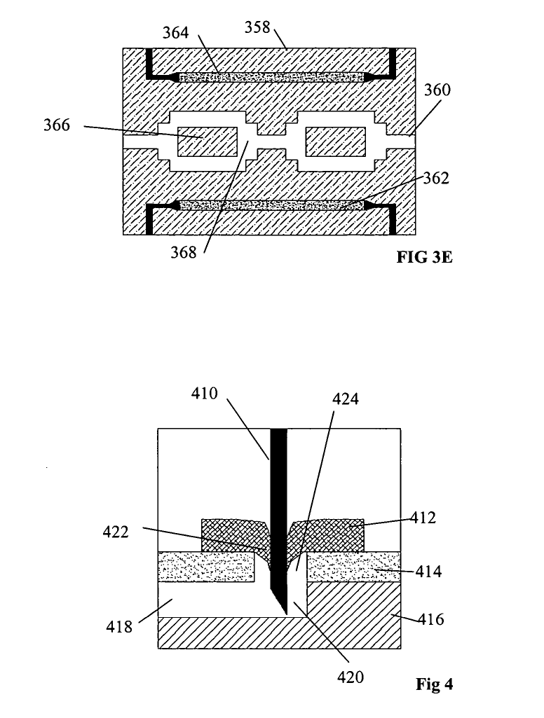

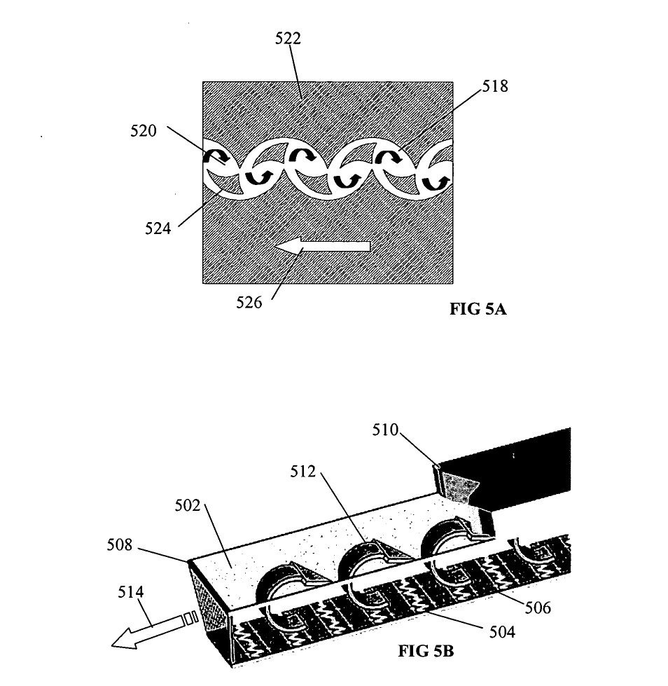

The controllable heat exchanger may be used to maintain and adjust the temperature of the nucleation, growth, growth termination, and/or any other sections. Heat may be added or removed from these sections by the heat exchanger. The heat exchanger may include resistive heater elements in the channels, resistive heater elements within the walls of the substrate and isolated from the reactant fluids by the thin substrate walls, channels adjacent to the reactant fluid channels through which a heat exchange fluid is passed to remove or add heat to the reactants, and Peltier devices. Heat exchangers may include but are not limited to one or more of a hot or cold fluid flow heat exchanger in co-flow or counter-flow mode, a hot or cold gas flow heat exchanger in co-flow or counter-flow mode, an infrared focused bulb, a laser or combinations of these. Alternatively, any or all of the fluid reservoirs, mixing paths, and the various sections such as the nucleation section, the growth section, the purification section, and the termination path may incorporate at least one cooling device or a fluid path to add a diluent or growth terminating reagent. In some cases, the resistive heaters creating temperature gradients may be positioned within the substrate and used for convective mixing, either across the flow channel as illustrated in FIG. 3E or in-line with it as illustrated in FIG. 5B. A temperature measuring device 330, such as an RTD or thermocouple, as illustrated in FIG. 3A, and 506 in FIG. 5, may be in the fluid path or adjacent to it and measure the temperature of the reagents in each of the sections.

A controllable heat exchanger may also be used for cooling an electronic component of a microfluidic module. The heat exchange device may contain an operating fluid in thermal communication with the electronic component on or embedded in the microfluidic module. The microfluidic heat exchange device being fabricated with a plurality of device layers including a stencil layer having a thickness and defining a microfluidic channel or chamber through the entire thickness of the stencil layer, wherein at least one device layer of the microfluidic heat exchange device incldues a self-adhesive tape material, the microfluidic heat exchange device further having a fluidic inlet and a fluidic outlet in fluid communication with the microfluidic channel or chamber such that the operating fluid enters the fluidic inlet at an inlet temperature and exits the fluidic outlet at an outlet temperature. A heat rejection apparatus may be fluidically coupled to the microfluidic heat exchange device, the heat rejection apparatus can be adapted to receive the operating fluid at substantially the outlet temperature and return the operating fluid to substantially the inlet temperature.

Glass has about a factor of ten lower thermal conductance than silicon, and air or vacuum pockets can be etched through the silicon for lateral insulation when capped with glass wafers. An alternative would be to add additional insulating blankets and external heaters. Chemical vapor or physical vapor deposition deposited glass or silicon nitride thin films can be used to passivate and insulate flow channels and devices. The temperature distribution across the channel will be affected most by geometry and the mixing structures, but heat can also be pulsed alternately from either side of the flow path using resistance heaters. Reducing the channel width further and deepening it in the thermally conductive medium, (eg. Si) will minimize temperature gradients if desired. Conversely, increasing the channel width and fabricating shallow trenches will increase temperature gradients. A set of parallel channels can compensate for reduced volume flow rates in high aspect ratio channels.

The heater element may be comprised of a pure or alloy metal thin film, a heat conducting metal oxide, nitride or carbide thin film, a doped semiconductor thin film, or combinations of such materials formulated to provide a heater with a low or substantially zero temperature coefficient. Heaters can be sputtered platinum or tungsten, of in-spot, gradient, and distributed types. Sputtered indium tin oxide, transparent sheet heaters can be deposited on glass parts and still maintain optical access.

Insulating fluid, aerogel, xerogel, vacuum or foam filled pockets, 114, 118, 124, and 126 as illustrated in FIG. 1 may be used to thermally isolate different sections of the flow path in a single module or to thermally isolate adjacent modules from each other and the ambient environment. Inlet and outlet ports may also be provided to these pockets through vias for flow of a temperature-controlled fluid (not shown).

Embedded temperature sensors such as platinum resistance sensors may be used as part of the controllable heat exchanger. Platinum resistance temperature sensors conform to standard calibration curves over the temperature range of interest. The use of four-lead measurements or alternating current measurements can be utilized to eliminate lead and contact resistances and thermal EMF's (electromotive forces) that distort accuracy. Thus, temperature gradients, thermal response times (thermal time constants) and temperature drift may be determined and feedback control may be provided. Preferably there should be less than 0.5° C./day drift. Bonding integrity of heaters by pull and peel force tests and temperature cycling may be performed with structures tested to about 6.9×10⁵ N/m² without delaminating over multiple temperature cycles from 25° C. to 350° C. Liquid tight seals around metal leads can be formed by anodic, thermal, adhesive, glass frit bonding, or other means as known in the art.

Any or all of the reservoir, the mixing path, the nucleation section, the growth section, and the growth termination section, or any other section of the flow path may incorporate a cooling mechanism. The cooling mechanism may include but is not limited to a liquid flow or counterflow conduit 112 or channel containing a fluid, a thermoelectric heater (Peltier device) made of bulk or thin film thermoelectric materials, or a combination of these.

The mixing path and/or flow path, the nucleation section, the growth section, and the termination path or any other section or module may incorporate a mechanism for generating temperature gradients with controllable heat exchangers across any of the following dimensions; the path dimension in the plane of the reactor, the path dimension perpendicular to the plane of the reactor, across the flow, or the dimension along the flow path length. The temperature gradients may be generated by means of the position and applied power of heaters and coolers, by means of the positioning and shapes of chosen materials, by the application of optical power or by any combination of such elements.

Preferably the microfluidic modules are fabricated from chemically inert, thermally stable materials that have appropriate thermal conductivity or are coated with materials having such properties. Without limitation the size of the substrate for the microfluidic module can be determined by the length and number of the flow paths in the module, their cross section, and need for thermal isolation pockets, sensors, fluid inlets, outlets and ports. The thermal conductivity can be high, low, or graded as appropriate for the desired uniformity. The microfluidic modules may, for example, be based on a silicon and glass micromachined microfluidic platform (because of high temperatures and inertness) utilizing bonding techniques known in the art. Materials may include but are not limited to bulk or thin film glasses, sapphire, doped and undoped semiconductors, silicon compounds such as SiC, or Si₃N₄, as well as metal nitrides, metal carbides, and metal oxides such as tungsten carbide and Al₂O₃. The microfluidic module(s) may be fabricated of bonded layers of doped or undoped silicon, polysilicon, doped or undoped silica glass, crystalline ceramics such as aluminum oxide and nitride, zirconium oxide, metal plates of Ni, Fe, Au, Ag, Pt, Ta, Nb, Mo, or any combination thereof. The materials may be polycrystalline, single crystalline, or amorphous. It may also be fabricated of bonded layers of one or any of a combination of polymers; such as, but not limited to silicones, polyimides, PEK, PEEK, PEM, PFA and many others known in the art.

In the exemplary FIG. 1A, microfluidic modules 102 are constructed of a multiplicity of layers of materials with fluid channels to provide internal fluid mixing, temperature control, sensing and other functions, such as heaters, coolers, ultrasonic agitation, micropumps and microvalves in intimate contact with the fluids. The main structural channel layers may be doped or undoped silicon, doped or undoped silica glass or other amorphous inorganic materials, crystalline ceramics such as aluminum oxide and nitride, zirconium oxide and many others, and may further contain many types of polymers, either as fluid channels or adhesives and parts of other functional devices associated with the operation of the microreactor. Optical feedback can be used to control the reactor operation, especially in the case of fluorescent nanoparticles, because the size is directly correlated to the optical properties of the nanoparticles, such as visible light emission under deep blue or ultraviolet light excitation. The ability to incorporate optical fibers or provide “windows” of appropriate transmission capabilities in the deep blue and ultraviolet allows photo-activated reactions to be induced by lamps or lasers of those wavelengths in the nucleation stages, reducing the temperatures needed and, when optimized, reducing side reactions.

FIG. 1B shows a cross section of the microfluidic module(s) 102 shown in FIG. 1A. The module shown can have a bottom layer 146 with one or more vias 140 and 142 through the bottom layer for sensors including optical fibers and temperature sensors, or for fluid inputs and outputs. The bottom layer may be bonded to a substrate layer 148 having one or more channels formed into it on either side (not shown) and isolated from the vias. The substrate layer 148 may be bonded to a top layer 150 that encloses the channels in the substrate 148 to provide a fluid path conduit, heat exchange conduits, and isolation pockets. The top layer may include one or more input and output ports as illustrated by structures 104, 120, and 122.

The particular layers and combinations of layers forming the fluid channels of the FIG. 1 exemplary microfluidic section(s) and/or module(s) can be chosen according to the temperatures and chemical compatibilities necessary for the particular reactor product. They may, for example, involve several additional coating steps of thin layers of other materials up to several micrometers thick, such as coating silicon with silicon dioxide or silicon nitride. The reactor fluid channel layers can, for example, be bonded together with appropriate means, including, but not limited to, organic adhesives, glass frit, pressure and temperature, ultrasonic or laser welding, or preferably by anodic bonding as is commonly done with silicon-to-silicon bonding or silicon-to-glass bonding.

The microfluidic module(s) may be constructed of a multiplicity of substrate layers, each including channels that may be either continuous or discontinuous over the surface area of the layer. Microporous/nanoporous membranes from ceramic frits and anodically etched, passivated aluminum may be incorporated into module(s). Porous silicon, germanium, or other semiconductors may be adapted for nanofiltration, purification, and mixing. The layers may be separated by materials, such as porous membranes, materials chosen to endow the microreactor with specific properties, for example chemical stability, purification, internal fluid mixing, temperature control, temperature uniformity, thermal isolation, sensing and other functions, such as heaters, coolers, ultrasonic agitation, micropumps, or microvalves.

The microfluidic modules of the present invention may have channels in the flow path which can have a maximum cross sectional dimension of about 10 nm to 10 mm, but preferably from 1 μm to 500 μm, and the length of the sections on the order of 0.1 μm to 50 m, but preferably have lengths from 1 mm to 5 m. The microfluidic module(s) may be connected to at least one precursor reservoir external to the microfluidic module(s). The reservoir may have a volume of up to about 100 liters, but preferably about 100 ml to about 5 liters.

Where the microfluidic modules have one or more sections, the length and cross section of the channel may vary. Preferably for nucleation a the channel may have a length from about 1 μm-5 cm. Channels wherein thermal pre-conditioning of reagents occurs prior to entry in a section of a module, such as described in Example 2, preferably have a lengths of 1 mm-10 cm. The growth section of a microfluidic module preferably has a channel length of from about 1 mm to 5 m and may be varied depending the rate of growth of crystals and the size crystals to be formed in a given module. Growth termination stops the growth of nanocrystals by quenching fluids to a temperature which inhibits substantial nanocrystal growth and preferably the channel has a length of from about 0.5 mm to 100 cm. Preferably purification or solvent exchange modules minimize the amount of coordinating solvent used while reducing the time of the exchange process and preferably the solvent exchange or purifier channel lengths range from about 1 mm to 5 m.

The flow path in the microfluidic module(s) can consist of a meander-type microchannel etched into silicon and capped with anodically bonded glass. The flow path in the microfluidic module(s) may have any shape or a combination thereof including but not limited to those with rectangular, square, trapezoidal, circular, semicircular or multi-faceted cross section fabricated by forming an open channel into one or more planar substrates. The cross section of the channel or microchannel depends upon the fabrication process used and more than one channel shape may be used. The channels formed in the substrate may be coated with thermally conductive materials or have heat exchange elements formed on their surfaces. The one or more fabricated planar substrates having channels forming the flow path may be bonded to other substrates, for example planar or etched substrates in order to form one or more closed fluid flow paths. The channel may have a most preferred width of about 1-3000 μm and/or a depth of about 1 μm to 400 μm and may be designed to minimize sharp corners and other dead volumes for accumulating particles and reagents. These smaller dimensions enhance the ability of the reactor to provide the same growth conditions for all the nanoparticles, decreasing the size distribution, providing a consistent thermal environment, and controlling the speed of the reaction. One or more fluid inputs may be used to introduce nanocrystal-forming reagents into the nucleation section of the microfluidic module. As shown in FIG. 1A there are two fluid inputs that, for example, use septa on the nucleation module for introducing the reagents into the system. As shown in the FIG. 1A, additional ports may be positioned along the channel to enable manipulation of the process by addition or removal of reagents, solvents, and other fluids. An example of a port is shown in greater detail in FIG. 4 where needle 410 is shown piercing septum 412 to form a fluid tight seal joint 422 between the needle 410 and septum. The septum may be held in place by a threaded compression fitting (not shown) bonded to the layer 414. Substrate 416 which is bonded to layer 414 has an inlet channel to the flow path 418 and a via 420 in fluid communication with layer via 424.

Gases may be generated during reactions and may be removed by bleeding off vapors (e.g., methane or Cd-containing vapors) into sealed reservoirs or they may be used to aid mixing. Pressure drop calculated estimates for the microfluidic modules pressure drops are about 6.2×10⁴ N/m² (9 psi) or less. Control of pH and mixing rates can control flocculation and precipitation, and Brownian motion may be used to keep the particles suspended or to sort by size using the field flow fractionation technique. The flows can be pulsed, if desired, using valves or pump modulation.

Solvent pulsing in cross flow (a field flow fractionation technique) may be used to keep particles away from membranes in a microfluidic module and may also be used to mix fluids without islands in the channels, allowing the use of larger pores. Reactor modules of this invention, and indeed other fluidic devices, may be tested with fluorescent or magnetic nanoparticles. The magnetic moment of an aliquot of magnetic particles could be measured, for example on a vibrating sample magnetometer and the effluent could be measured to determine the losses in the channel. Excited fluorescent particles could be used for direct observation for testing and quality control during production. Sonic actuators may be used for manipulating the particles with standing waves.

Size sorting in a microfluidic module(s) may be accomplished when a cross channel force is applied by pulsing the pressure through the membrane to drive the particles to the opposite wall, from which they are gradually released by size by Brownian motion. Pulsation can be applied alternately from opposite sides of the membrane to keep the particles in the center of the channel and away from the membranes. A sonic standing wave can be used to slow or halt the particles while the liquids exchange around them. Modules can be placed in series or in parallel to increase the flow capacity and/or manipulate the order of various reactor functions.

The microfluidic modules may have a channel or flow path that includes one or more mixing structures for mixing or combining fluids having different temperature or compositions that are introduced or present in the flow path during the continuous flow process. The mixing structures can be islands or changes in channel directions or dimensions, in the fluid flow paths that are constructed internally to the flow channels and are fixed structures wherein the structures are designed to manage and manipulate the fluid in order to achieve component mixing and/or thermal control. Thermal control can be directed toward causing each nanoparticle or nucleus to experience the same or nearly the same temperature and time at temperature even though the flow remains laminar. The microfluidic module or a column including interconnected microfluidic modules may incorporate at least one internal mechanism for mixing the fluid in any section or fluid reservoir, including the mixing path, the nucleation section, the growth section, the purification section, the ligand solvent exchange sections, the growth termination section, and any other section.

For example, as shown in FIG. 3A, a “garden rake” mixing structure is provided. Structures are formed inside the channel in order to enhance the physical and/or thermal mixing by dividing and recombining the flow. The islands are shaped to get the highest mixing efficiency while creating minimum dead volume to prevent particle accumulation or clogging. As an illustrative, non-limiting example, silicon can be etched completely away in sections to localize thermal properties and allow intentional gradients to be established. The nucleation section, incorporating mixing in a short distance, can operate at 200° C. to 350° C. in the example chemistry, and incorporate a temperature gradient and temperature control structures and devices. As illustrated in FIG. 3, the structure can have a first fluid inlet channel 302 formed in a substrate entering a manifold of one or more smaller channels 304 to divide into parts a reagent or fluid from the channel 302. A second fluid flow inlet channel 306 formed in a substrate enters a manifold of one or more smaller channels 308 to divide a second reagent or fluid present in the channel 306. The fluid in channels 304 and 308 combine in a structure 316 which may have a funnel shape. Further mixing or combining and thermal equalization of the nanocrystal forming reagents may occur in flow path channel 310 where one or more islands 312 are formed in the flow path channel 310 to split and recombine the flow stream. Also shown in FIG. 3A are heater 320 for heating the mixed reagents in the flow path 310 and temperature sensor 330 for measuring the temperature of the reagents. Another illustrative example of a two level mixing structure is shown in FIG. 3B. In this structure, a flow path 104 in a substrate 334 includes one or more porous semiconductor membranes 338 at the nucleation or mixing position 110. The flow path mixes or combines nanocrystal-forming reagents from one or more inlets 104 and 106 guided by channels 332 and 336. The cross section of FIG. 3B is shown in 3C. Another illustrative example of a single level mixing structure is shown in FIG. 3D, where flow paths 350 and 352 are channels in substrate 346. The flow path 354 includes one or more islands 340 or necks 344 for mixing and thermally equalizing combined fluid reagents. A heat exchange element or sensor 356, may be embedded in the substrate 338 for monitoring or conditioning fluid in the flow path 354.

Fluid mixing can be effected by changing any or all of the cross sectional area, the direction of the flow path or by dividing and recombining fluid streams using internal flow directors, while the laminar flow conditions are maintained (Reynold's number<1000). Mixing within the flow path may also be effected including but not limited to the addition of physical barriers, or changes in the direction and dimensions in the fluid flow path, or utilizing sonic or ultrasonic energy to agitate the fluid by means of sonic or ultrasonic actuators. The sonic or ultrasonic agitation may be induced by piezoelectric or magnetic means. Other mixing methods may include gas bubbles, water hammer, the inclusion of ripples or other features in the channel walls, physical agitation, and the fabrication of flow paths on multiple levels of the substrate. FIG. 5A illustrates the circulating mixing flow 518 of a reagent fluid in flow path channel 520 in substrate 522 and enclosed by another layer (not shown). Islands 524 are positioned in the flow path 520 to mix the fluid with direction of local flow 518 and direction of average flow, 526. FIG. 5B shows a trapezoidal shaped channel 502 in a substrate 508 forming an enclosed portion of flow path with layer 510 bonded to substrate 508. Heat exchange elements 504 in thermal contact with the channel bottom are shown with interspersed temperature sensors 506 also in thermal contact with the channel bottom. Convective mixing 512 by action of the heat exchangers is also illustrated. Fluid mixing in the flow path or reservoirs may further be effected by using an energized moving part such as a motor impeller which can be magnetically activated, fluid driven, piezoelectrically driven, activated by capacitance changes or thermally activated. Mixing in the system may be effected by Brownian motion only.

The microfluidic module(s) of the present invention may have one or more reactant mixing paths. A mixing path can have a length that ranges from about 0.1 μm to 50 m, but is preferably 1 μm to about 5 m in length. A mixing path in the microfluidic module(s) may be in fluid communication through the flow path channel with at least one inlet path, where at least one inlet path is linked to at least one internal or external reservoir.

In the example chemistry, after the endothermic nucleation reaction in the nucleation section of the microfluidic module, temperature equalization can be established by including a fixed gradient to reach the chosen growth and maturation temperature. It may also be necessary to control the endothermic reaction with the addition of heating to extend and control the cooling gradient. For the example chemistry, nanocrystal growth will use a longer channel of constant temperature in the range of about 50° C. to about 450° C., and preferably 100° C. to 300° C. which can vary depending upon the desired nanocrystal size as well as upon the chemistries used. The temperature, reagent concentrations, and/or flow rate can be varied to control particle size. In order to allow more control, growth modules with different serpentine lengths can be manufactured using simple photolithographic mask changes.

A controllable fluid delivery device is one in which the amount, mass or volume and rate of fluid delivered to a microfluidic module(s) may be controlled independently or by a feedback control loop in which one or more sensors are used to regulate the flow of fluid into and out of the flow path. For example, where the size of nanocrystals formed is determined to be too large by their fluorescent emission, the signal from the optical sensor may be used by the controller to increase the rate of flow of material into the flow channel to shorten the residence time of nanocrystal forming reagent in the flow path of a growth module and thereby decrease the size of the formed nanocrystals back to a desired size. A controllable delivery device includes but is not limited to pumps, motor driven syringes, microfluidic flow controllers, or combinations of these Various controllable fluid delivery devices may be used to controllably remove fluid from the flow path of a microfluidic module. For example a motor driven syringe, a pump, or source of reduced pressure can be used to actively remove fluid from the flow path. An actuated valve connected to a reservoir may be opened and closed in response to a controller signal to remove pressurized fluid from the flow path. A controllable fluid receiving device is one in which the amount, mass, or volume and rate of fluid removed from the flow path in a microfluidic module or reactor may be controlled. The flow rate of fluid in one or more microfluidic modules can be adjusted without limitation to control process throughput as well as the size of nanocrystals that are formed. Flow rates may be in the range of from 1 uL/min to 10 mL/min(10000 uL/min), preferably 0.01 mL/min (10 ul/min) to 0.5 mL/min (500 ul/min). The residence time of fluid in the flow path of a module will vary with is length and the flow rate. For example, the total volume of the nucleation module with an 8 m flow path 250 um×250 um size in cross section is 0.5 mL; the residence time in the nucleation module may range from 1 minute to 50 minutes depending upon the flow rate chosen and whether the fluid flow is continuous in the flow path. Pulsed flow may be used to further increase residence time.

Continuous flow, defined by continuous net forward flow in the reactor (module) column regardless of interruptions in flow caused by for example, fluid diversion for purification, for ligand exchange, or for storage. Fluid can be provided in continuous laminar flow, as continuous plug flow, or as laminar flow with bubbles. Local fluid movement can be in a direction different to, including opposite to the net forward flow in the reactor.

A continuous flow process is one in which reactants are fed into a microfluidic module(s) continuously for periods of time and product nuclei, nanocrystals, or coated nanocrystals are formed in one or more modules and removed from an outlet of a microfluidic module. Reactant fluids may also be fed into the flow path in aliquots to create plug flow conditions in the microfluidic modules or the reactants may be continuously fed into the flow path. A gas can be periodically injected into the flow stream to accomplish mixing at the phase boundaries. The rate by volume of liquid flowing in a reactor may be chosen to permit an appropriate residence time for the fluid in a given area or point in a module(s).

The microfluidic modules of the present invention, as well as reactor columns formed by interconnection of one or more microfluidic modules, may be supplied with chemical reactants, solvents, gases, or other fluids from external reservoirs. These fluids may be delivered to the flow path channel by applying pressure to inject and flow a fluid stream through the flow path. Pressure may be applied to the fluid such as but not limited to the use of a fluid source pressurized by an inert gas, a syringe, or a mechanical pump. Fluid flow within the microfluidic module or columns may be achieved using devices internal to the flow channels. Examples of such devices include but are not limited to electro-osmotic pumps, centrifugal pumps, thermal pumps, piezoelectric pumps, sonic and ultrasonic pumps and diaphragm pumps. The net direction of fluid movement in the flow path channel is preferably in the direction of an external reservoir for collection or to a growth termination section of the flow path. The flow direction however can at any point, be reversed or stopped in order to effect mixing, dilution, to equilibrate temperature variations, or for any number of other reasons.

Various nanocrystal forming reagents may exhibit sensitivity to one or more contaminants such as but not limited to water, oxygen, or various ions. The nanocrystal forming reagents, reservoirs, microfluidic modules, and microfluidic reactors may have structures for purging the reagents and conduits with an inert gas to maintain the properties of the reagents and formed nanocrystals. The modules may be enclosed in an inert gas atmosphere such as a purge box or glove box. On particular advantage of the present invention is that formed nanocrystals may be isolated from harmful fluids like air until they have been suitably coated.

Constant displacement pumps may control the flow through a continuous system. Fluid stream pressures can be matched for different flow rates and densities of reactants by adjusting the channel dimensions and internal structures. Single port valves or breaking the reactor column into sections may also be used to control flow and processing.

Internal cleaning of the reactor, particularly particles trapped in the reactor can be accomplished by but is not limited to using inert gas bubbles, treatment with sonic energy, by creating plug flow, or by a flow of solvents though the reactor in a continuous or pulsed manner.

The microfluidic module(s) can be fluidly connected with at least one reservoir that provides chemical reagents to the flow path. The reservoir can have multiple outlets to provide reagents to a plurality of microfluidic modules. The fluid reservoir(s) and linkage path can be controlled at temperatures different from or the same as room temperature and/or any of the microfluidic module(s). Preferably the chemical reagent reservoir(s) can be recharged by refilling or by exchange with another source of the chemical reagent(s) without breaking the continuous flow into the reactor. For example, fluid dispense pumps such as the Intelligen® available from the Mykrolis Corporation may be used with valves in an exchange/purge configuration to continuously supply chemical reagents to microfluidic module(s) or microfluidic columns made from interconnected microfluidic modules.

A continuous flow process may include soak time wherein the flow of fluid is stopped and does not interfere with upstream processes. For example, after growth termination it may be desirable to feed the fluid containing the nanocrystals into one of several parallel microfluidic modules connected to the flow path of a microfluidic reactor for purification and/or ligand exchange. The growth termination section, or any other modules or sections, may be joined or fluidly connected with a detachable flow path such as a tube or cannula inserted through septa (sterility not required) at the inlet and outlet of the two modules. Where necessary the interconnect conduit may be heated or cooled as necessary. A volume of fluid may be fed into a selected module(s) and mixed with solvent or another reagent and allowed to soak for a period of time after which it is returned to the main flow path of the microfluidic reactor. It is desirable that the flow through the nucleation and growth sections be continuous, whether the flow is laminar, mixed, or for example contains bubbles, and that the flow of the desired end product be continuous regardless of any interruptions in flow interior to the assembly of reactor sections or modules for the example purposes of storage, purification and/or ligand exchange.

The microfluidic module(s) may be constructed of a multiplicity of substrate layers, each including channels that may be either continuous or discontinuous over the surface area of the layer and may have one or more passages through the layer to other layers. Valves to control fluid flow directions may be incorporated into module(s) and/or in connecting fluid lines, including for example, check valves which eliminate unwanted back flow. As a non-limiting example, for higher temperature applications (350° C.), valves based on silicon can be used to meet the thermal requirements of the valving material. In lower temperature applications, polymer valves are sufficient. Actuators used on the high temperature valves can be thermally isolated from the valve body or cooled in order to prevent overheating due to high temperature of the fluids. In the event that a reactor requires more modules than can fit onto a single wafer or surface, interconnects between the adjoining modules may employ thin film PZT ultrasonic transducers, located at the interconnects, to facilitate particle movement. A socket system modeled on a Luer-lock socket may be used. The operational temperature can dictate the materials used.

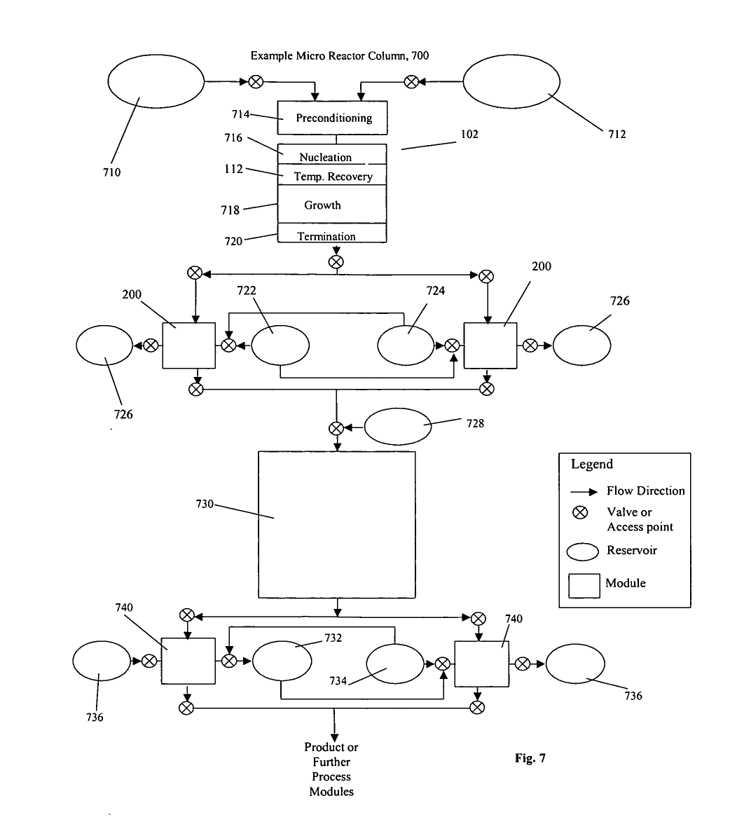

An illustrative diagram of a non-limiting example reactor made from interconnected microfluidic modules is shown in FIG. 7. The illustrative block diagram in FIG. 7 of as non-limiting examples indicates flow direction, valves, junction points, reservoirs and functional sections and modules.

The system of interconnected microfluidic modules of FIG. 7 may include portions of the flow path for nucleation, growth, purification, ligand exchange, secondary growth, as well as thermal control elements, sections or modules (insulating elements, heaters, coolers). Each section or module may incorporate micro-sensors and actuators, including temperature sensors, heaters, coolers, optical sensors, mixers, valves, and pumps. The columns can be installed with modules joined in series or parallel linear arrangements as well, in order to increase capacity or provide necessary manipulation of the reagents.

FIG. 1 shows an example non-limiting illustrative microfluidic chemical reactor for the continuous flow manufacture of chemically produced nanopartices. The FIG. 1 exemplary continuous flow microfluidic module embodies many improvements in its ability to control the chemical reactions used to produce well-controlled chemically produced nanoparticles. It can be termed a microfluidic module because the dimensions of its fluid channels are constructed with cross sectional dimensions on the order of about 10 nm to 5 mm, but preferably from about 1 um to 500 um in one illustrative non-limiting implementation. These smaller dimensions enhance the ability of the reactor to provide the same growth conditions for all the nanopartic1es, improving the size distribution.

As shown in FIG. 1, the exemplary microfluidic module 102 preferably includes a structure 102 having a plurality of input ports 104, 106, and possibly additional input ports. Microfluidic channels 108 communicate the input ports 104, 106 to a rapid reaction mixing area 110 that mixes materials provided to the input ports in order to obtain a chemical reaction. A fluid cooling loop 112 may be used to circulate a cooling liquid in order to cool the mixing results. Thermal isolation pockets 114 may be defined in the structure 102 to provide thermal isolation. A crystal growth section 116 may be used to grow nanocrystals from the resulting reaction results. In the exemplary embodiment, crystal growth section 116 is comprised of a serpentine arrangement of micro fluidic channels. The channels of the exemplary FIG. 1 arrangement can be of rectangular, square, or trapezoidal cross section or in any other desired shape such as round or semicircular to accommodate the necessary incorporated internal structures.

In one exemplary arrangement, standard isotropic wet etch techniques may be used to provide channel structures for mixing and uniform growth conditions. One or more downstream input and/or output ports may also be provided by isotropic etching if desired. Alternatively, reactive ion etching or deep reactive ion etching can be advantageously used to form complex shapes in and of the flow channels as well as deep through-wafer vias.

The FIG. 7 reactor or reactor column can advantageously contain more than one section or module. More than one module can for example be joined in series or parallel, as necessary to control the flow, remove bottlenecks or like functions. For example, the first module can contain entry ports 104, 106 for at least two input chemicals, comprising the precursors to the reactor product, to be introduced and reacted. The input ports 104, 106 can lead to one or more rapid mixing points 110 that are purposely constructed to combine all input chemical streams at once or at appropriate intervals in order to properly and controllably nucleate the nanocrystal growth (ie., the nucleation stage of the reactor product). Temperature and flow control of the input streams and mixing points are, in one exemplary implementation, precise and accurate enough for the requirements of the reactions.

As will be understood from the FIG. 1, an exemplary non-limiting arrangement, the microfluidic module 102 provides continuous flow and production of at least single compound core nanocrystals. Appropriate chemical compositions may be continuously injected into the input ports 104, 106. Liquid cooling loop 112, can continuously remove heat from the chemical reaction, and the crystal growth section retains the reaction results under appropriate control conditions for sufficient time to provide desired nanocrystal growth. The resulting nanocrystal output may be continuously removed from output port 122 and further processed by subsequent microfluidic sections and modules, or by using conventional batch processes if desired. Reagents may be removed at any of the ports 120 if desired, for example to change the particle size removed, or reagents may be added at any of these points for purpose of, for example, changing the sizes and/or shapes of the nanocrystals.

Batch post-processing At the final output 112 of the exemplary microfluidic reactor 100, comprised of a module assembly, it may be desired to maintain the nanocrystal reaction product without further change in size. Even though at this or any other point of the complete nanoparticle, coated nanoparticle or functionalized nanoparticle production the nanoparticles can be removed from a microfluidic reactor for processing by conventional batch processes, this is with in the intent and purpose of the present invention. Size sorting can thus be performed, for example, by centrifuging or in a purification microfluidic module if the size distribution is wider than the requirement and the product of either of these methods can be fed back into a subsequent microfluidic module. This process may be continued by interconnecting additional batch processes, microfluidic reactors or microfluidic modules to add other optically or physically compatible semiconductor, inorganic, organic or biological coatings, as appropriate to the application and without limitation.

Each nucleation, growth, and termination section of the module may have one or more fluid inlets, fluid outlets, and channels. For example, nanocrystal nuclei may be formed in a single nucleation channel and distributed to multiple growth sections each maintained at a different temperature or having a different length for controlling the size of the formed nanocrystals. It may also be desirable to facilitate the rapid termination of the nanocrystal growth by distributing nanocrystals in a fluid into one or more growth termination channels incorporating heat exchangers.

Any of the microfluidic modules may have heat exchangers located near inlets, outlets, or ports on the module for pre-conditioning the fluid. Preferably the a microfluidic module having a nucleation section includes uniformly heating or cooling a single premixed incoming flow stream or multiple incoming flow streams by means of a controlled temperature ramp and/or a sudden temperature step using such as those shown in FIG. 1. A post-conditioning module, comprised of a channel can follow the nucleation mixer with means 112 to provide heat if the reaction is endothermic or provide rapid cooling of the reacted chemicals if the reaction is exothermic in order to control side reactions and associated unwanted reactor byproducts. The growth section can be used to control particle sizes and their size distributions. A longer growth section, 116 of channel can follow, up to several meters long, incorporating passive mixing structures or active mixing devices designed to keep all crystallites in the chemical stream in substantially equal contact with the temperature controlled channel walls for equal times in order to assure that each particle is subjected to substantially identical growth conditions. The mixing methods as examples in FIGS. 3 and 5 illustrate, are desirable to overcome the stratification effects inherent to laminar flow because the Reynolds number in these systems is generally several orders of magnitude below the conditions necessary for turbulent mixing. The growth conditions may use different temperatures or temperature gradients than used in the nucleation functional section.

Additional inputs and outputs 120 of liquid or gaseous chemicals can be incorporated for various purposes along the growth channel in order to, for example, replenish a reactant that is depleted by a side reaction or loss to the gas phase, remove a gas phase or utilize bubbles for mixing. The input chemical flow can be controlled by several methods common in the fluidic art. In one arrangement, constant volume rate pumps, such as syringe pumps, can be utilized to prevent the necessity of measuring the flow rate in the event of pressure changes in the system.

Where the growth section forms a continuous channel with a growth termination section, formed in the substrate as part of the flow path of the microfluidic module, the growth of the nanocrystals received from the growth section can be terminated or quenched during the continuous flow process. The growth termination section includes a heat exchanger for maintaining the growth termination section at a temperature for quenching nanocrystal growth and an inlet and an outlet in the flow path. The growth termination section inlet is in fluid communication with the outlet of the growth section of the microfluidic module, and the growth termination path outlet is used for removing formed nanocrystals from the growth termination section and flow path. Additional sections for coating or purification of crystals may be made in the flow path channel of a microfluidic module without limitation. The growth termination section outlet can preferably be capable of forming a fluid tight seal with other microfluidic modules for subsequent coating or purification of the formed nanocrystal.

Purification and ligand exchange microfluidic modules may be made by similar methods used to form channels in the microfluidic module used for nucleation and/or growth. For example, as shown in FIG. 2B, the purification module may have a substrate layer 250 having a channel 220 with inlet 210 and outlet 212 for nanocrystal-containing reagent flow and a channel 244 for purification and/or ligand exchange reagents formed by etching the substrate, the channels fluidly connected and separated by a porous membrane 262, for instance an organic or fluoropolymer filter membrane. The channel 220 and a manifold (not shown in FIG. 2B) and other heat exchange structures are enclosed by a layer 252 bonded to the substrate layer to form enclosed channels. The channel 244 and a manifold or heat exchange structure (not shown), are enclosed by a layer 254 bonded to the substrate layer 250 to form enclosed channels. Fluid port 260 and outlet port not shown in FIG. 2B may be used to provide channel 244 with counter flow rinsing, reverse flow membrane clearance, or to remove filtrate containing dispersed nanocrystals from flocculated nanocrystals for further separation. Similarly, two membrane layers can be advantageously disposed on either side of the particle channel and the purifying or exchange fluid can be pulsed or continuously flowed across the direction of particle flow. To prepare the nanoparticles for ligand exchange, TOPO, TOP, or other coordinating solvents (for example, Lewis bases) are exchanged and possible contaminants are removed from the nanocrystal particles. A microfluidic purification module may be used for this purification step and advantageously will eliminate the need for centrifuge steps, which in the batch process requires the nanocrystals to be taken from the closed system and purified in multiple size selection operations, and possibly in contact with air. The purification microfluidic module may used field flow fractionation (FFF) plus nanopore filtration, tangential flow filtration, sonic mass filtration, a drift rachet device (for example, anodically etched porous silicon or GaAs with modulated pore diameters), electrically activated hydrophobicity/hydrophilicity, and gel bed (size exclusion chromatography) filtration or a combination of these. All purification modules can be identical in construction or can contain different functional sections as desired. The temperatures and flow rates at which they are operated may be different or the same, for example. The solvents used may be different or conversely the molecules can be altered to accommodate different solvent properties or to accommodate the passage of nanocrystals though the membranes in some cases.

In one embodiment, a purification module can include a separation device that includes a first flow path having in inlet and an outlet that is in fluid communication through the membrane with a second flow path. The second flow path has an inlet and an outlet and contains a device to pulse the pressure of the fluid in the first flow path. The separation device may have a piezoelectric, magnetic or optical means of inducing sonic or ultrasonic waves in the first flow path for the purpose of separately manipulating nanocrystals in the fluid.

Where the ligand exchange process takes considerably more time than can be handled in a continuous flow column created in a specific area on a single wafer or surface, the temperature can be increased until within the breakdown limits of the reactant fluids or the reactor materials. In addition or instead, the number of ligand exchange modules may be increased by the connection of multiple microfluidic exchange modules in parallel. The product coming out from the preceding module can be diverted to successive exchange modules by valving if necessary or desired.

As shown in FIG. 2, a purification or ligand exchange microfluidic module has a flow path that is a channel in a substrate material. The module may have one or more layers having channels that are separated by at least one porous membrane material (polymeric, ceramic, metal, nucleopore). Each layer of the module can include an inlet or entry point where a fluid including nanoparticles or an exchange fluid enters the module, a flow path that is a channel, and an outlet where fluid, including nanoparticles that have been purified or exchange fluid are removed from the module. The inlet and outlet may be regulated by septa and the outlets can be exchanged with inlets by valving. The module may also include one or more solvent or exchange fluid entry ports on each layer. As described in the specific Examples, the exchange fluid is mixed with the nanocrystals and separation occurs by exchange fluid flow over nanocrystals and precipitation onto a smooth surface opposite the membrane. Once the precipitation process is complete, which may be measured by time or the composition of the filtrate, for example, a cross force from an applied pulsing exchange fluid flow stream may be applied to the membrane(s) to dislodge the particles if they are trapped and transfer them to another microfluidic module for subsequent processing, or similarly ultrasonic energy can be applied.

The purification steps are usually performed at or near room temperature in known chemistries. The purification section may have temperature sensing that is implemented with resistive sensors, p-n junction sensors or thermocouples, pressure sensing in the module can be accomplished with diaphragms equipped with piezoresistive, optical or capacitive sensors, and the flow sensing in the module accomplished by constant volume displacement, thermal mass flow or moving mechanical elements, as desired. A nanopore filtration module could therefore be made with polymers as well as with anodically etched semiconductors or metal oxides. A three dimensional microfluidic device can be formed by placing a membrane between two channel patterned substrates. The patterning may involve parallel or intersecting channels between the first and second substrate, wherein the membrane is positioned to cover the area where the channels overlap. A microfluidic module may be provided with multiple solvent entry and waste exit ports. A non-limiting example would be a porous film such as a ceramic frit or anodically etched silicon, capped with nanoporous alumina, which could be placed inside the main cavities, separating each into two or more shallow chambers having a common porous wall. The porous wall would allow the solvent to move back and forth between the two chambers but prevent the movement of nanoparticles between them by means of pore size, surface state or early precipitation of the nanoparticles onto another surface. When in operation, the mixture containing nanoparticles and excess reagents would be transported to one of the chambers as shown in FIG. 2 and would be flushed with a pulsing steam of solvent in order to eliminate the excess TOPO (melting point 50-54° C.) or other coordinating ligand. Another method to effect purification, coordinating, or using porous membrane filtration would be to use two porous membranes and pulse the particles back and forth across the particle flow channel to prevent fractionation and promote rinsing or ligand exchange, as the case may be. Field Flow Fractionation, FFF, has been used to sort particles using Brownian motion to release the particle by size after they are trapped opposite the pulsing membrane in an asymmetric mode in a macroscopic fluid process (Wyatt Technologies, Inc.). Using two membranes can avoid size sorting if it is desirable that the particles pass through the channels without variable delays. Conversely, size sorting can be accomplished by applying FFF with or without the employment of two membranes.

A sonic particle filter may be constructed in a microfluidic purification or solvent exchange module and uses the principle that the relatively massive suspended particles can be trapped in sonic standing waves in the liquid while the liquid continues to flow. The particles can be driven either upstream or downstream by varying the frequency of the sonic waves. Ultrasonic energy may also help rinse the particles by increasing their relative velocity and energy and can also be used in combination with a filtration-based microfluidic purification module.

A gel bed filtration device may be used in a microfluidic purification module and would consist of a cavity or channels coated or filled with a material such as Sephacryl 500HR (Amersham Pharmacia Biotech). This process is sometimes called size exclusion chromatography, and incorporates the alternate trapping of particles on and elution from (by means of an elution buffer) a separating gel. The sample volume is generally less than 1/10 of the bed volume, which could consist of beads placed in the channels or islands of such material built into the channels. As in the nanofiltration method, the elution process would alternate the introduction and removal of fresh fluids, or complete the process in a continuous, counter-flow mode. Alternately, opening and closing valves on several such microfluidic modules to place them into and out of the nanocrystal particle stream may be used purify greater volumes of material and also be used to prevent process bottlenecks. Although this processes uses a larger volume of solvents than other methods of purification, it is still much ‘greener’ than the centrifuging process used in typical batch crystal growing processes known to those skilled in the art. In addition, when optimized, it will require less solvent than larger continuous flow systems since proportionally less excess solvent is used in the microfluidic reactor requiring less to be removed.

For nanocrystals utilizing a shell layer over a core nanocrystal, for example ZnS-capped CdSe fluorescent nanocrystals, the shell may be grown over the core particles in the flow channel of a growth section in a microfluidic module(s). This shell growth module, in which the ZnS coating is applied, may be constructed with the same or other techniques as the core growth module, except provision is be made to add the Zn and S-containing reactants of the example chemistry at a very slow rate to avoid agglomeration of particles rather than the coating of the CdSe core crystals. The temperature is also much lower than that for core growth and the reaction does not cause the swings in temperature that the nucleation reaction causes. Nanocrystal coating will use temperatures in the range of about 30° C. to about 250° C., which can vary depending upon the size of the core nanocrystal desired, reaction rate desired, and coating chemistries used. For instance, a manifold such as 240 in FIG. 2A may be formed in a microfluidic growth module for the gradual introduction of the shell-coating material to the flow path.

The final nanocrystal product would desirably be ready for packaging into containers directly from the final module of the reactor. A system that includes multiple microfluidic sections or modules, i.e., a reactor column, may be housed in a standard vented chemical hood attached to a drybox through a load lock. In a non-limiting example, the nanocrystalline product can be collected in a container large enough to hold reactor effluent for a 24 hour period. At that point, any nanocrystal product that is compatible with atmospheric exposure and can be removed for the packaging of aliquots.

Where desired, a final or next-to-final coating section may be used in the reactor to apply an additional coating to the surface of the crystals in order to prepare the particles for functionalizing for water (biological) environments or organic solvent environments. An optional microfluidic module may be incorporated into the reactor as a process step for conjugating the nanoparticle to an active biological molecule such as Avidin™.

Advantages of the present invention include rapid and repeatable preparation of nanocrystaline materials that are used in many areas of biology, medicine, toxic detection, and optoelectronics. The particular application that they are used for depends upon the ability to selectively tag and detect compounds, cells and organisms, and to build unique functional structures in increasingly diverse ways and in smaller and more efficient sizes (for instance in “self-assembly” techniques). For example, the most prominent tagging technologies involve fluorescent chemicals such as rhodamine and ethidium bromide, radioactive tracers such as iodine (125) and magnetic nanoparticles. Fluorescent nanocrystals have the potential to not only replace fluorophores and dyes in many applications, but to greatly expand the range and efficacy of fluorescent marking in applications such as immunochemistry, DNA analysis, cancer pathology, clinical testing and diagnosis, bio-agent detection, cell selection and selective culture and research assays. Fluorescent nanocrystals do not photobleach as readily as dyes, produce much lower background contamination (are more specific), are less toxic, are excited by the same ultraviolet wavelength for all colors and are more readily passivated and conjugated for biological uses. They can be used to augment radioactive tracer and magnetic particle tagging. Their applications in physics have only begun to be explored. They could replace dyes in lasers, be used as building blocks in photonic bandgap crystals (using biological self-assembly techniques), be used to adjust emission color of hybrid LEDs, and find use as very fast scintillation detectors in nuclear physics and medicine.

Batch processes are inefficient and lack control of size dispersion (color sharpness). A microfluidic, continuous flow approach will provide greater control through exposure of the reactants to more uniform and known conditions. Lower amounts of solvents will be used. The microfluidic processes are “greener” than batch processes.

Advantageously, microfluidic modules allows for joining of similar modules made of compatible materials in series or parallel at minimum expense, allows built-in continuous mixing and/or thermal equalization, and the use of microsensors with feedback. Rapid design changes are possible with photolithographic techniques in combination with modeling feedback. Much more rapid thermal changes and equilibrations are possible in comparison to large volume methods. This advantageously provides improved run-to-run repeatability as well as elimination of many time consuming, dangerous labor tasks, and reduces the overall consumption of chemicals used in the process.

Various aspects of the present invention will be illustrated with reference to the following non-limiting examples.

### EXAMPLE 1

This prophetic example illustrates the fabrication of a microfluidic module for the purpose of making nanocrystaline materials with wet chemistry.

A module to nucleate and grow nanocrystals to the desired final size and size dispersion, incorporating reactant preconditioning, nucleation, reaction-induced thermal imbalance recovery, growth and growth termination sections, may be made on a single substrate.

A (100) oriented, double side polished silicon wafer of a resistivity and conductivity type chosen for easy wafer bonding, and of sufficient diameter and thickness, is provided with a silicon dioxide layer on one side and a silicon nitride layer on the other. Silicon has a relatively high thermal conductivity, it is tolerant of chemicals and high and low temperatures and has many standard and well known coating and forming methods associated with it. The oxide side is patterned (“patterned” will be taken to mean photolithographically by means of standard photoresist processes) for metal lift-off in the form of the desired heaters and sensors, electrical lead-ins and electrical contact areas. See for example FIG. 1 #138, 140, 142 on substrate 146.

A metal, for example platinum, tungsten, chromium or molybdenum, or a combination of such metals, is deposited to the desired thickness, to support current density and resist electromigration during heating, and composition by standard physical, chemical vapor or electroplating means over the wafer and is processed into the desired patterns by dissolving the photoresist. In order to form cavities and channels in the silicon, a second pattern is formed in the silicon dioxide using reactive ion etching or wet chemical etching. Silicon is chosen to be the substrate to host the fluid channels in this case because it can easily be etched and bonded either to glass or silicon without the aid of adhesives. A metal masking layer, such as Al, can be applied in the desired pattern to further protect the parts of the Si to remain un-etched, or an organic layer such as polyimide or photoresist can cover the parts of the wafer to be protected. Wet isotropic etching, such as in hot KOH, could be used with just the patterned oxide for protection if the channels are not deep, or if the channels are to be deep, silicon nitride could be used on both surfaces of the wafer. Deep reactive ion etching (DRIE), with a process such as the Bosch process, could be used to form deep channels in conjunction with the oxide and metal masks. Mixing and thermal equalization structures are included in this pattern, preferably the mixing structures in the channel are those that split and remix the fluid. The A1 mask is easily removed without harming the Pt sensors and heaters with a commercial etchant.

The channels can now be passivated by physical or chemical deposition of an silica glass layer that can be anodically bonded to a glass cover wafer, such as Corning 7040 glass. This glass layer can be chemically/mechanically planarized if necessary by commercially available polishing methods if necessary for the wafer bonding processes. The nucleation and initial thermal conditioning sections in this simplest example are formed in the same single channel level as the thermal recovery and crystal growth sections. Nucleation and mixing structures can be formed with multiple levels by straightforward extensions of the described processes.

Sensors and resistance heaters can be formed in the channels at this time by similar techniques utilizing mask aligners such as the Suss Microtech model MA6/BA6. The glass sealing wafer (FIG. 1b, #150) is now anodically bonded to the silicon substrate 146 by an anodic process at about 300-350° C. and an applied voltage of about 750-1200V, preferably in an inert atmosphere. Both substrates are meticulously cleaned first, and the layer 150 has any access holes, such as electrical contact holes and fluid ports already formed in it. Such holes can be formed by ultrasonic or diamond grinding or reactive ion etching. The alignment of the features on the two wafers can be for example performed on a mask aligner such as the Suss MA6/BA6 and the wafers transferred to a bonder such as the Suss SB6 in a Suss transfer fixture.

The two-wafer assembly can now be turned over and the back-side openings for thermal isolation and other functions can be formed by patterning the silicon nitride layer and opening windows by RIE. The front side and edges of the of the two-wafer assembly can be protected, for instance by waxing the module into a cavity in a chilled block of PEEK (polyetherethyketone) so the edges of the silicon are not attacked, and the through-holes can be etched in hot KOH or a similar isotropic etchant. The through-holes can also be etched with RIE.

A layer of silica glass suitable for wafer bonding is now applied over the backside of the silicon wafer and the assembly is once again anodically bonded to a backside glass layer. The anodic bonding of the thick glass layer or wafer, or a low ion content glass such as fused quartz, can be made possible by doping the surface with ions such as Na or P in a furnace or by ion implantation. Anodic bonding can further be performed in a vacuum to enhance the insulating properties of the silicon cavities. Alternatively, the backside glass wafer can be adhesive bonded with a high temperature adhesive, for instance, silicone, or a different back side sealing material, such a polymer (e.g., PEEK), can be utilized, although the thermal and stress balance of the assembly will be enhanced by using the same glass as the front side.

The fluid port seals are applied by using a curable silicone rubber compound or a preformed rubber compound that is inserted into a cavity in a compressed form and released. The module can now be attached through an electrical socket, which may include an optical path, to the power sources and signal acquisition hardware and software, as well as the reagent delivery and receiving devices and applied to grow nanocrystals.

### EXAMPLE 2

This prophetic example illustrates the utilization of a microfluidic module incorporating appropriate sections for the purpose of making CdSe core nanocrystals with wet chemistry using a microfluidic module made by the process of example 1.

Prepare 1.0M trioctylphoshine selenide (TOPSe) by dissolving selenium pellets (99.99% purity, ˜2 mm pellet size, Aldrich Chemical Company) in trioctylphoshphine (TOP, tech grade quality or better, density=0.831 g/mL, Aldrich Chemical Company). Leave until a single-phase homogeneous solution is obtained. For the method in which two input reagents are employed, two separate constant volume pumps are used, in this case, two syringe pumps. In a glove box or using standard Schlenk line techniques, syringe 1 is charged with a sufficient mass of dry trioctylphosphine oxide (TOPO), heated above 55° C. (melting point, 50-54° C., tech grade quality or better, Aldrich Chemical Company). In a glove box, or using standard Schlenk line techniques, syringe 2 is charged with reagent fluid comprised of a sufficient amount of TOP, dimethylcadmium (Me₂Cd, 97%, reagent grade or better, density=1.985 g/mL at 18° C., Strem Chemical Company), and TOPSe in a mass ratio of TOP:Me₂Cd:Se in TOPSe of 100.0:1.0:0.4.

The two syringes are placed in the syringe pumps and connected to the microreactor module 102 through the ports 104 and 106. Port 104 is constructed with a larger diameter to accommodate different viscosities of the two reagents and the flow rate of approximately 200 parts by mass TOPO to the approximately 100 parts by mass of reagent fluid entering through port 106 and the fluids are pumped at equal pressures to prevent backflow into either port.

TOPO entering port 104 is heated along a gradient from 55° C. to the desired reaction temperature, which may be varied under automatic control due to embedded sensors such as 142, to from 250° C. to 350° C., but is usually about 300° C. The dimethylcadmium-containing reagent fluid entering through port 106 is kept at or near room temperature. The TOPO and reagent fluid meet at the point 110 and mixing is effected using mixing structures located in the fluid stream, as in FIG. 3b and Example 1.

Similarly, by choice a single mixed reagent can be input by one pump. In the one reservoir application, the TOPO, TOP, Me₂Cd, and TOPSe are pre-mixed in the ratios above to make up the reagent fluid and are used to charge a single syringe for a single syringe pump. In this application, the syringe is heated to approximately 55° C. This mixture should be limited in the time and temperature to prevent premature nucleation.

The single mixture reagent solution enters the reaction through a single port and is carried towards the point 110. At the point 110, the fluid undergoes a sharp temperature ramp from a spot heater, such as 144, to a high temperature to effect nucleation. In the case using CdSe, a temperature of approximately 300° C. will effect nucleation.

In both the one and two input reagent cases, an endothermic reaction associated with nucleation of the CdSe nanocrystals causes a thermal imbalance that is recovered to an appropriate temperature at or near the growth temperature, for example, 160° C., in a recovery section 112.

The crystals are grown in the growth section channel at the growth temperature, for example, 160° C. until they are of appropriate size.

The crystal size can be determined from time/temperature data history or by the active means of exciting the flow path with deep blue light of about 490 nm wavelength and observing the visible fluorescence, which exhibits a well-known correlation between emission wavelength and nanocrystals diameter, as in one of the methods of FIG. 6.

The product is cooled to less than 64.7° C. in a growth termination section, lower than the boiling point of methanol which can be used to precipitate the product. The growth termination section can be implemented by a fluid heat exchanger as in FIG. 1, 132/134 or externally in the connecting tubulation to the fluid receiving device.

The crystals are collected from port 122 as (CdSe)TOPO/TOP to be used as is in s subsequent batch process, they can be dissolved in an appropriate solvent and used, or purified and processed further all within a microreactor column sealed against exposure to air.

### EXAMPLE 3

This prophetic example illustrates the fabrication of a microfluidic module for the purpose of purifying, or separating nanocrystals from their first containing fluid reagent, and replacement of the first fluid reagent with a second fluid reagent, using wet chemistry. It would be advantageous to have one or more modules to purify nanocrystals without exposing the nanocrystals to air or using batch methods such as staged centrifuging.

The purification may be performed in a dedicated detachable module or the function can be integrated into a module that includes other functions such as growth and growth terminaton. The same method of manufacture can be used for a ligand-exchange section or module. A first silicon wafer is chosen with polishing and pin-hole free silicon nitride on both sides. The wafer doping and type is chosen consistent both with the anodic etching of desired pore sizes in the range of 100 nm to 10 μm and also to allow anodic wafer bonding.

The first wafer is patterned in the flow path pattern, as in FIG. 2A channel 220, and the silicon nitride is removed with RIE, for example in an argon, oxygen and CF₄ mixed gas atmosphere at a temperature between 50 and 150° C. The excitation can be microwaves at about 13 MHz or 2.4 GHz using capacitive or inductive coupling. The mirror image pattern is aligned on the opposite (second side) of the wafer with a backside aligner such as the Suss MA6/BA6 and the silicon and the nitride layer is removed on the second side as well. The first side of the first wafer can either be patterned with the entire flow channel pattern open to bare silicon or with a two dimensional ordered array of dots which are patterned within the flow channel pattern first, if ordered pore spacing and size is advantageous or desired. With an ordered array pattern, the open dots are used to create etch pits in a KOH bath to initiate the pores in the silicon. After pore initiation, the nitride around the pits will be removed to the full flow channel width. With no etch pits to start the pores but with the relatively larger space of the flow channel open, the pores will self-initiate and will be disordered. The total pore area will be more controlled with the photolithography and etch pits.

Next the first wafer is anodically etched in an HF-containing electrolyte in a standard manner except that bath parameter feedback control is used to enable pores to be deep etched within the flow channel depth of the second side. This may be, for example, 450 μm deep pores, leaving 50 μm un-etched. Different etching method details are be used for n-type or p-type wafers.

In this purification reactor section, temperature sensors and heaters can be applied to the capping or sealing wafers 252 and 254 on the outsides of the sections, but if it is desirable to place them on this wafer for local monitoring and control, they can be applied to the second surface of the capping wafer in the manner of Example 1.

The second side flow channel is now formed by RIE through the second side silicon nitride mask, and in the process the pore ends are revealed.

In some applications, depending on the relative viscosities and other parameters of the fluids, micrometer size scale pores are appropriate. If smaller pores are desired, a layer of aluminum is applied to the pore ends on the bottom surface of the flow channel in order to plug the pores. The aluminum is then anodically anodized in a well-known manner in, for instance, hydrochloric, oxalic or phosphoric acid electrolytes to convert the aluminum to aluminum oxide and to simultaneously form nanometer-scale pores in as thin a layer as needed to manage the fluid exchange without significant nanoparticle penetration. This completes the flow path for the input nanocrystals-containing reagent except for a sealing layer with input/output ports.

To ready the first silicon wafer for bonding, both sides are either stripped of nitride or coated with a silica glass layer with enough ion content to facilitate anodic bonding.

A second silicon wafer is then patterned in the flow pattern of, for example, FIG. 2A to match the pattern on the first side of the first wafer and the nitride is removed in this pattern. The second side of the second silicon wafer is then patterned to remove the nitride in the areas of the fluid input and output ports. The flow channel for the diluent reagent is formed in the first side of the second wafer by RIE using the typical method of Example 1. Fluid input/output ports are formed in the second side of the second wafer, also by the RIE process.

The second wafer is prepared for wafer bonding by either stripping the nitride or coating both sides of the wafer with a high ion content silica glass by chemical vapor or physical vapor deposition.

The two wafers are cleaned and aligned, then transported to the bonder and anodically bonded as described in Example 1. The first side of wafer two is bonded to the second side of wafer one. At this point, the fluid exchange membrane is sealed to the diluent reagent flow path.

It is desirable to have a glass cap on the side of the nanocrystals reagent flow, especially, so the state of the flow channels can be observed and the nanocrystals can be observed by fluorescent output. Thus, the capping glass wafer for the first side of the first wafer (nanoparticle channel) can be prepared as necessitated by the chemistry and temperature limitations of the materials. A preferred configuration is to prepare the glass wafer by drilling through-holes for the input/output ports as in Example 1, and coating the side opposite the silicon with a composition of In/Sn oxide for a front side blanket heater that maintains the optical transparency of the glass. Electrical contacts are then applied to two opposing edges of the In/Sn oxide layer and the glass is cleaned, aligned with the first side of the first wafer and anodically bonded.

Fluid port seals are then applied as in Example 1, except there is now a minimum of four. Sensors may be applied on the silicon surface as in Example 1, the glass surface next to the silicon with an insulating ion-containing glass layer over them, or to apply sensors to the top or outside glass surface with adhesive or some other common means. Where desired., the second glass wafer may be bonded to the second surface of the second silicon wafer for thermal and stress symmetry, with or without sensors and In/Sn oxide heater, or to simply insulate the backside by other common means. The purification/ligand exchange section or module is connected to the fluid input and output devices and the electrical socket fabricated for it, to be ready for use.

### EXAMPLE 4

This prophetic example illustrates the utilization of microfluidic modules for the purpose of purifying or separating nanocrystals from their first containing fluid reagent and replacement of the first fluid reagent with a second fluid reagent. Method of exchanging ligands and/or purification.

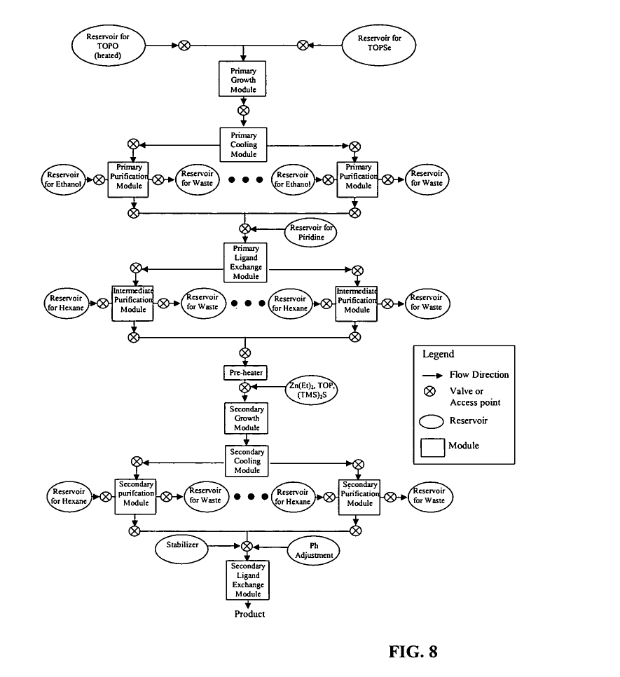

Two identical modules of Example 3 are fabricated and hooked by short stainless steel tubing of about 250 μm to a valved manifold in the manner of FIG. 8 so that the two modules can be alternated in receiving nanocrystal-containing output from the module of Example 1. The manifold also contains valved supply reservoirs for a methanol/ethanol mixture with about a 1% addition of hexanes and valved supply reservoirs for pyridine, as well as valved reservoirs for waste. The manifold is kept at 50 to 60° C., including the valves and connecting tubing.

A solution of CdSe/TOP/TOPO can be introduced into port 210 in FIG. 2 from a batch process, but preferably directly from the module of Example 1 without any exposure to air or change from the 50-60° C. temperature. The two parallel Example 3 modules are positioned horizontally with the nanocrystals flow path on the bottom side of the porous membrane because of advantageous density and stratification characteristics of the fluids. The CdSe/TOP/TOPO is flowed into the first Example 3 module and the module is valved off.

The second parallel Example 3 module is then opened to the CdSe/TOP/TOPO, nanocrystals-containing reagent, and the filling process is repeated as in the first module.

The CdSe/TOP/TOPO section is filled to approximately 80% capacity. There the unpurified CdSe/TOP/TOPO reagent is flushed with methanol/ethanol solution to cause precipitation of the purified product. A complex 3-phase mixture is produced, namely a top layer that is methanol rich with TOP and TOPO dissolved in it, a middle layer that is a red oil, and a bottom layer that is a white crystalline material. The product rich layers are the middle and bottom layers, but the bulk of the product is precipitated on the bottom.

The alcohol mixture is circulated through the second (top) flow path until red liquid is detected in the waste reservoir (by a filtered photodetector). The with the aid of the valving, both flow paths are flushed until the solution is clear and substantially alcohols, with the white nanocrystals precipitate on the bottom of the bottom flow path. Both sections of the parallel purification section are then flushed with pyridine to effect the ligand exchange of TOPO and TOP for pyridine. In addition, the (CdSe)/pyridine crystals form a stable suspension in pyridine, bringing the precipitated crystalline material back into the fluid flow. The excess solvent, which is mostly methanol (density 0.791 g/mL) but can have some pyridine (density 0.978 g/mL), is removed from the waste ports of the two flow paths. At this time, the roles of the two Example 3 modules are reversed. The purification/ligand exchange is effected in module 2, and the CdSe/TOP/TOPO, nanocrystals-containing reagent from the Example 1 module is admitted to the first module and flushes out the remaining pyridine and is ready for the purification cycle.

The purification cycle can be repeated indefinitely, and can be adjusted for capacity by either adjusting the sizes of the Example 3 modules or placing more in parallel. The diluent fluid, whether it is alcohols or pyridine, can be pulsed in pressure with a frequency of a few Hz to adjust the rate of penetration of the porous membrane and to promote mixing during any or all of the above process steps. Using the valving system, the purified product, (CdSe)/pyridine in pyridine solvent can be received from the purification/ligand exchange section by a fluid receiving device. The receiving device can be a shell-coating module or section as in FIG. 8, or it could be a storage device such as an expandable, air-tight reservoir.

### EXAMPLE 5

This prophetic example describes a microfluidic reactor assembled from microfluidic modules connected in series to form semiconduction fluorescent nanocrystals.

The microfluidic reactor has a number of microfluidic modules connected to form a flow path. The flow path is formed in a one or more substrates which make up the modules. The first microfluidic module has a nucleation section and a growth section on the same module and also includes a temperature controllers for controlling one or more heat exchangers for each section in the module. The microfluidic module has a first fluid inlet where a combination of nanocrystal reagents such as Cd(CH₃)₂, TOSe, and TOP are dispensed in a controlled manner from a heated syringe reservoir into the first inlet. The module has a second inlet where a coordinating solvent such as TOPO is dispensed in a controlled manner from a heated syringe reservoir. The fluids from the two reservoirs are mixed at an inlet having a structure of FIG. 3A or FIG. 3D in the flow path. Nucleation of nanocrystals occurs when the temperature of the inlet of the nucleation section is sufficient to cause supersaturation to occur which is about 300° C. Nucleated semiconductor nanocrystal formation is indicated by a color change in the solution. Nucleated crystals flow from a thermally isolated, short nucleation section in the flow path, into the longer growth section of the flow path. The flow rate of the nanocrystal reagents in the flow path and the length of the flow path are chosen to provide a residence time of the formed nanocrystals in the growth section ranging from about 10 minutes to greater than 180 minutes. The temperature of the growth path may be maintained at a temperature of about 240 to 290° C.

Formed nanocrystals leave the microfluidic module with the nucleation section and growth section and enter the growth termination module through a conduit in fluid communication with both module channels and making fluid tight connection with each. The growth termination module may include a channel for a heat exchange fluid to cool the nanocrystals in the flow path to below about 70° C. A temperature controller and temperature sensors may be used to monitor the fluid temperature and control the heat exchanger. A port in the flow path is used to make a controlled dispense of butanol, to prevent TOPO solidification, into the flow path as the reaction mixture cools. The location of the port may be changed depending upon how quickly the reaction mixture cools and the size of the channel in the flow path increase to accommodate the extra fluid volume. Measurement of the nanocrystal size and distribution can be made by fluorescent emission of the growth terminated nanocrystals the flow path as illustrated in FIG. 6A.

Where the FWHM is 50 nm or less for a predetermined size of the core nanocrystal, the CdSe nanocrystals can be directed to the inlet of a microfluidic module for coating with a shell layer of ZnS. The microfluidic module for overcoating has a flow path and one or more independently controlled heat exchanger and ports along the flow path for adding nanocrystal forming reagents such as diethyl zine and hexamethyldisilathiane.

The overcoated nanocrystals may be cooled in a growth termination module and directed to a ligand exchange module where the TOPO coordinating solvent on the surface of the nanocrystals is exchanged for another coordinating ligand.

The growth terminated nanocrystal are removed from the outlet of the growth termination microfluidic module by a conduit making a fluid tight seal and are transferred to a microfluidic module in which ligand exchange or physical separation of flocculated nanocrystals may be effected as illustrated in FIG. 2(A-C) The ZnS overcoated nanocrystals enter a first flow path in the purification module that has a channel formed in a first substrate and enclosed by a second substrate and has a fluid inlet and a fluid outlet. A separation device such as a membrane 262 or 246 is in the flow path for removing impurities or aiding in solvent exchange with the nanocrystals in the fluid. The flow path inlet in the purification modules receives nanocrystals such as but not limited to CdSe nanocrystals with a ZnS overcoat in the carrier fluid from the growth termination module. The purification module has one or more optional port in a second flow path 244 through which exchange solvent like pyridine are added. The separation device may include a porous membrane through which the nanocrystals are prevented from passing and fluids are allowed or caused to be exchanged by cross-flow, counter-flow, or co-flow from a second fluid path 244 separated from said first flow path by the membrane. The separation device membrane can be a porous membrane having pores in the membrane that permit the passage of dispersed nanocrystals or the separation device can have a semiconductor membrane with internal pore dimensions modulated in order to cause nanoparticles to pass through by means of a drift ratchet property. The membranes of the separation device can be made from semiconductors, silica glass, metal oxides or polymers and may be caused to be hydrophilic or hydrophobic by means of the application of a voltage or by chemical modification of their surface.

The solvent may include TOP and TOPO and the microfluid modules within the microfluidic reactor are capable of heating these materials from about 55° C. to about 360° C. within about ±5° C. Temperature control to within about ±1° C. or better may be achieved, nucleation gradients which can be linear are maintained within ±5° C. or less. Microfluidic mixing with island structures as shown in FIG. 5A, microsensor feedback and control may be used to control temperature in each section. For constant temperature process sections ±5% of temperature or less for a fixed interval of time may be used. The growth temperature may be adjusted based upon the optical size measurement and feedback control. Reactant may be mixed thoroughly within 1 cm or less using (various mixing structures in the flow path which do not trap or segregate particles by their size).

Optionally the CdSe particles may be purified or separated after the growth termination stage. Preferably the microfluidic modules result in reduction of solvent usage by at least 75% over batch process and at an exchange rate wherein 95% of the TOPO is exchanged in less time than a batch process. Ultraviolet or sonic energy (those which accelerate ligand exchange but do not result in crystal growth) may also be used and results in less toxic pyridine usage.

Although the present invention has been described in considerable detail with reference to certain preferred embodiments thereof, other versions are possible. Therefore the spirit and scope of the appended claims should not be limited to the description and the preferred versions contain within this specification.

1. A microfluidic module comprising:
a flow path comprised of a channel formed in a first substrate and enclosed by a second substrate, the flow path having a fluid inlet and a fluid outlet;
mixing structures in the flow path; and
one or more independently controlled heat exchangers in thermal contact with the flow path for conditioning a nanocrystal forming reagent within the flow path; the flow path inlet receives the nanocrystal forming reagent and conditioned nanocrystal forming reagent is removed from the flow path at the outlet, the flow path inlet and outlet capable of forming a fluid tight seal with one or more controlled fluid delivery devices.

2. The microfluidic module of claim 1 having multiple flow paths.

3. The microfluidic module of claim 1 further wherein the heat exchanger includes an optical source of energy.

4. The microfluidic module of claim 1 wherein the flow path further includes sensors chosen from the group consisting of: particle size sensor, pressure, flow, reagent chemical composition sensing, the sensor output used as an input to a controller for open or closed loop control or said microfluidic module.

5. A microfluidic module of claim 1 wherein the controlled heat exchanger includes a temperature sensor, a heat exchanger, and a controller.

6. The microfluidic module of claim 1 wherein one or more of the independently controlled heat exchangers thermally preconditions the nanocrystal forming reagent.

7. The microfluidic module of claim 1 wherein the first substrate includes one or more thermal isolation structures whereby the flow path is separated into one or more thermally isolated sections.

8. The microfluidic module of claim 1 wherein one or more additional ports are provided at intervals along the flow path for the purpose of adding reagents to modify the shapes, surface coating, and/or sizes of the growing nanocrystals, the one or more ports located between the inlet and outlet of the flow path and capable of forming a fluid tight seal with one or more controlled fluid delivery devices.

9. The microfluidic module of claim 1 wherein the mixing structure mixes multiple flow streams uniformly by dividing the flow stream into multiple smaller streams, the smaller streams being mixed and reacted and recombined with the aid of mixing and thermal equalization structures internal to the flow path or paths.

10. The microfluidic module of claim 1 wherein said flow path includes a particle size sensor wherein fluorescent emission from said particles is utilized in open or closed loop control of temperature or fluid flow in the flow path.

11. The microfluidic module of claim 1 wherein the flow path includes a nucleation section whereby nucleation of nanocrystals occurs during a flow process, said nucleation section including a nucleation length of channel in the flow path, said one or more heat exchangers maintaining said nucleation section at a nucleation temperature, the nucleation section having an inlet in the flow path for receiving a one or more nanocrystal nuclei-forming reagent fluids and an outlet in the flow path for removing nucleated nanocrystals from the nucleation section.

12. The microfluidic module of claim 1 wherein the flow path includes a growth section whereby growth of nanocrystals and/or nucleated nanocrystals nuclei or nanocrystals occurs during a flow process, said growth section including a growth length of channel in the flow path, one or more ports for adding nanocrystal forming reagents, said one or more a heat exchangers maintaining the growth section at a growth temperature, the growth section having an inlet in the flow path for receiving a nanocrystal forming reagent fluid, and an outlet in the flow path for removing nanocrystals from the growth section.

13. The microfluidic module of claim 1 wherein the flow path includes a growth termination section in which growth of nanocrystals is terminated during a flow process, said growth termination section including a growth length of channel in the flow path, said one or more heat exchangers maintaining the growth termination section at a growth termination temperature, the growth termination section having an inlet in the flow path for receiving nanocrystals in a reagent and an outlet in the flow path for removing nanocrystals from the growth termination section.

14. The microfluidic module of claim 1 wherein the flow path further comprises a purification section whereby phase separation or exchange of fluids containing nanocrystals from fluids occurs during a flow process, said purification section including a separation device in a length of channel in the flow path, said one or more heat exchangers maintaining the purification section at a purification temperature, the purification section having an inlet in the flow path for receiving nanocrystals in a reagent and an outlet in the flow path for removing nanocrystals from the purification section.

15. The microfluidic module of claim 1 wherein the flow path includes a coating section in which a coating is formed on a stabilized nanocrystal in a flow process, said coating section including a heat exchanger for maintaining the coating section at a coating temperature, at least one coating section inlet in the flow path for receiving nanocrystals and coating forming reagent, and at least one coating section outlet in the flow path for removing coated nanocrystals from the coating section, the growth section inlet and outlet capable of forming a fluid tight seal with one or more controlled fluid delivery devices.

16. The microfluidic module of claim 1 comprising one or more sections chosen from the group consisting of nucleation, growth, growth termination, purification, and combinations of these in the flow path on a substrate.

17. A microfluidic module comprising:
a first flow path comprised of a channel formed in a first substrate and enclosed by a second substrate, the first flow path having a fluid inlet and a fluid outlet;
a separation device in the flow path for removing impurities from nanocrystals in a fluid, the first flow path inlet receiving nanocrystals in a fluid, said separation device removing impurities from the nanocrystals in the fluid and the first flow path outlet for removing the nanocrystals from the flow path, the flow path inlet and outlet capable of forming a fluid tight seal with one or more controlled fluid delivery devices; and
a port in the first flow path.

18. The microfluidic module of claim 17 wherein the separation device includes a porous membrane through which the nanocrystals are prevented from passing and fluids are allowed or caused to be exchanged by cross-flow, counter-flow, or co-flow from a second fluid path separated from said first flow path by said membranes.

19. The microfluidic module of claim 17 wherein the separation device includes a porous membrane having pores in said membrane that permit the passage of dispersed nanocrystals.

20. The microfluidic module of claim 17 wherein the separation device contains a semiconductor membrane with internal pore dimensions modulated in order to cause nanoparticles to pass through by means of a drift ratchet property.

21. The microfluidic module of claim 17 wherein the separation device contains membranes that can be caused to be hydrophilic or hydrophobic by means of the application of a voltage.

22. The microfluidic module of claim 17 wherein the separation device includes a porous membrane made from semiconductors, silica glass, metal oxides or polymers.

23. The microfluidic module of claim 17 wherein the separation device includes a porous membrane and the first flow path is in fluid communication through the membrane with a second flow path, said second flow path having an inlet and an outlet, wherein the second flow path contains a device to pulse the pressure of the fluid in the first flow path.

24. The microfluidic module of claim 17 wherein the separation device contains a piezoelectric, magnetic or optical means of inducing sonic or ultrasonic waves in the first flow path for the purpose of separately manipulating nanocrystals in the fluid.

25. The microfluidic module of claim 17 wherein the separation device includes a porous membrane and the first flow path is in fluid communication through the membrane with a second flow path, said second flow path having an inlet and an outlet.

26. A microfluidic reactor comprising:
a flow path including one or more fluidly connected microfluidic modules for making nanocrystals in a flow process, the flow path in each module is a channel formed in at least a first substrate and enclosed by at least a second substrate, said channel in thermal contact with one or more independently controlled heat exchangers along the flow path for conditioning a nanocrystal forming reagent fluid in the flow path, each module having an at least one inlet in the flow path for receiving the reagent fluid and and least one outlet in the flow path for removing conditioned reagent fluid from the module, each said inlet and outlet capable of forming a fluid tight seal with one or more fluid delivery devices.

27. The microfluidic reactor of claim 26 comprising one or more flow paths.

28. The microfluidic reactor of claim 26 comprising microfluidic modules with one or more inlets, outlets, or combinations of these.

29. The microfluidic reactor of claim 26 wherein the modules are connected in a manner to include parallel, series, or a combination of these.

30. The microfluidic reactor of claim 26 wherein a microfluidic module includes a reagent preconditioning section, a nucleation section, a growth section, and a growth termination section.

31. The microfluidic reactor of claim 26 wherein the channel flow path includes a mixing structure.

32. A method of making nanocrystals comprising:
conditioning nanocrystal forming reagents in a flow path, said flow path including one or more fluidly connected microfluidic modules for making nanocrystal product in a flow process, the flow path in each module is a channel formed in a first substrate, said channel in thermal contact with one or more independently controlled heat exchangers and mixing structures along the flow path to condition the nanocrystal forming reagents in the flow path; each module having an inlet in the flow path for receiving the nanocrystal forming reagent fluid and an outlet in the flow path for removing conditioned reagent fluid from the module, each said inlet and outlet capable of forming a fluid tight seal with one or more controlled fluid delivery devices; and
monitoring a detectable property of said nanocrystal product or reagent in a portion of the flow path and adjusting a controllable heat exchanger, a fluid delivery device, reaction time, or a combination of these to maintain the detectable property of the nanocrystal product in a pre-determined range.

33. The method of claim 32 wherein the nanocrystals forming reagents are fluorescent nanocrystal forming reagents.

34. The method of claim 32 wherein the mixing structures within the flow path divide and recombine the fluid flow of the nanocrystal forming reagents.

35. The method of claim 32 further including the act of purifying the conditioned nanocrystal forming reagents in the flow path.

36. The method of claim 32 comprising one or more flow paths.

37. A method of purifying nanocrystals comprising:
providing nanocrystals in a fluid into the flow path of a microfluidic module having a separation device in the flow path of said microfluidic module, and
separating an impurity from said nanocrystals within said microfluidic module.

38. The method of claim 37 wherein the impurity is a coordinating ligand, a solvent, nanocrystal forming reagents, particles, and combinations of these.

39. The method of claim 37 further comprising the act of providing a second fluid to the flow path from one or more ports along the flow path.

40. The method of claim 37 the separated impurity is a first ligand attached to the nanocrystals that is exchanged for a second ligand to be attached to the nanocrystals in the fluid.
